(19) United States
(12) Patent Application Publication
(10) Pub. No.: US 2017/0228930 A1
(43) Pub. Date: Aug. 10, 2017

(54) METHOD AND APPARATUS FOR CREATING VIDEO BASED VIRTUAL REALITY

(71) Applicant: Julie Seif, Warminster, PA (US)

(72) Inventor: Julie Seif, Warminster, PA (US)

(21) Appl. No.: 15/016,186

(22) Filed: Feb. 4, 2016

(51) Int. Cl. G06T 19/00; H04L 29/06; G02B 27/01; H04N 7/18

(52) U.S. Cl. CPC G06T 19/006; H04N 7/18; H04L 65/1063; G02B 27/017; G02B 2027/0178

(57) ABSTRACT

Within this disclosure, an apparatus which contains a plurality of cameras and software based method is discussed for allowing users to create 360 degree virtual worlds that mimic real life, made out of video captured from a plurality of cameras. This apparatus is designed to operate as an attachment to an immersive device such as but not limited to a HMD or VR device, in some embodiments it functions as a standalone apparatus, and in other embodiments it is designed have more than one function, so it is able to be used either as a standalone device or as an attachment for an immersive device such as but not limited to an HMD or VR device.

### CROSS-REFERENCE TO RELATED APPLICATIONS

Not Applicable

### SUBSTITUTE SPECIFICATION STATEMENT

This substitute specification includes no new matter.

### STATEMENT REGARDING FEDERALLY SPONSORED RESEARCH OR DEVELOPMENT

Not Applicable

### REFERENCE TO A SEQUENCE LISTING, a TABLE, or a COMPUTER PROGRAM LISTING COMPACT DISC APPENDIX

Not Applicable

### BACKGROUND OF THE INVENTION

The technology herein relates to the field of Head Mounted Displays and Virtual Reality devices and experiences provided by these technologies.

A problem existing among the field of VR and VR devices as a whole is that there are no existing methods for creating virtual worlds that truly mimic real life, or that make the user feel like they are experiencing things in the real world. There also lacks a method for users to create virtual worlds that allow them to share their real life experiences with others.

### BRIEF SUMMARY OF INVENTION

Described within this disclosure is various softwares and an apparatus which established a method of using camera(s) to create virtual world environments, referred to herein as a “real life virtual world” or “real life virtual world environment”, using cameras. These real life virtual world environments measure 360 degrees. Since these environments, consist of videos which were taken from the real world, virtual worlds that truly mimic real life can be created.

The apparatus disclosed within this disclosure contains multiple cameras. This apparatus can, in some embodiments, connect to a immersive device such as but not limited to an HMD or VR device to provide the device with additional cameras so it can capture 360 degree real life virtual worlds. In other embodiments, the apparatus provides all of the cameras to the connected immersive device such as but not limited to an HMD or VR device, because some of these devices on the market do not contain cameras.

In some embodiments, the apparatus can be used as a standalone device, in unison with a wireless device application that controls the apparatus. In other embodiments, the apparatus is designed have more than one function, so it is able to be used either as a standalone device or as an attachment for an HMD or VR device. Also discussed within this disclosure is the playback and method of controlling or interacting with created real life virtual worlds.

### BRIEF DESCRIPTION OF SEVERAL VIEWS OF THE DRAWINGS

FIGS. 1-11 illustrates an aspect of the invention which allows the user to create virtual worlds by recording one or more videos using an immersive device such as but not limited to a HMD or VR device.

FIGS. 12-18 illustrates an aspect of the invention which is an expansion pack containing additional cameras which allow the user to create virtual worlds which consist of videos which are recorded simultaneously from more than one camera, in accordance with some embodiments.

FIGS. 19-25 illustrates the user creating and saving a virtual world that consists of multiple videos, in accordance with some embodiments.

FIGS. 26-57 and FIGS. 59-66 illustrate the user viewing and interacting with virtual world(s) which consist of multiple videos, in accordance with some embodiments.

FIGS. 67 to 71 illustrate another embodiment of the aspect of the invention which is an expansion pack containing additional cameras which allow the user to create virtual worlds which consist of videos which are recorded simultaneously from more than one camera.

FIGS. 71A to 74 illustrate yet another embodiment of the aspect of the invention which is an expansion pack containing additional cameras which allow the user to create virtual worlds which consist of videos which are recorded simultaneously from more than one camera.

FIGS. 75 to 85 illustrate another aspect of the invention, a wireless device application which allows the aspect of the invention which is an expansion pack containing additional cameras to be commanded from.

### DETAILED DESCRIPTION OF THE INVENTION

Real Life Virtual Reality, simply put, is the user using camera(s) which is presented to the user in such a way, that it allows them to feel as though they are experiencing what the user who captured the video experienced while capturing the video. This process will now be described.

Within this disclosure, it shall be known that HMD stands for heads mounted display and that VR stands for virtual reality. It shall also be known that the words “Real Life Virtual World” or “Real Life Virtual World Environment” exist to describe virtual worlds which are created by capturing multiple videos simultaneously.

In the first aspect of this invention, an application exists which is installed onto a VR Device, HMD Device, Dual HMD and VR Device or any device which can provide an immersive experience, which allows the user to acquire video from one or more cameras which are included on a VR Device, HMD Device, Dual HMD and VR Device or any device which can provide an immersive experience and allows these videos to be saved with accurate data regarding their position for playback by the user. This application is designed to work with either a VR Device, HMD Device, Dual HMD and VR Device or any device which can provide an immersive experience on it's own or in conjunction with an expansion pack. The function of this application will now be described.

To describe this application, the non limiting example device in which the application is installed onto, is a Dual HMD and VR Device 100 which has camera(s) on the front of it, which capture the outside world and displays real time video of outside world which is acquired by the Dual HMD and VR Device 100's camera(s) on the display(s) of the Dual HMD and VR Device 100 for the user to be able to see. On top of the real time video which is acquired, on this Dual HMD and VR Device 100, applications such as the application which is about to described, can be launched, executed, and interacted with.

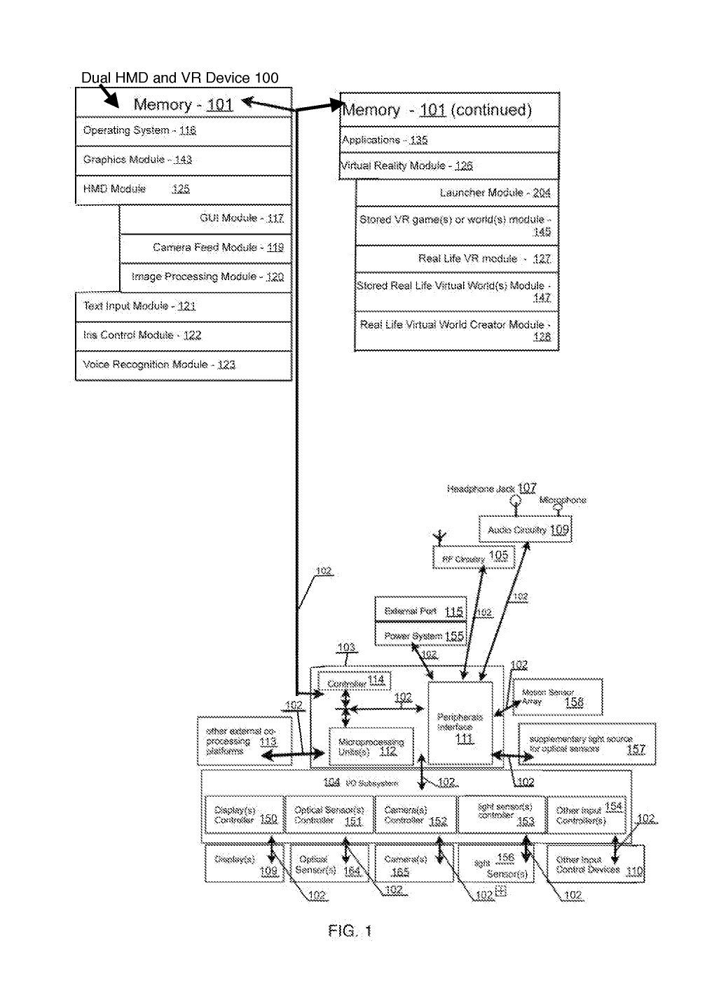

Attention is now directed completely towards the block diagram shown in FIG. 1. This non limiting example Dual HMD and VR Device 100 contains various hardware and software components, including memory 101 (which is one or more computer readable storage format), a memory controller 114, one or more microprocessing units 112 which may connect to one or more external co-processing platforms 113, a peripherals interface 111, a power system 155, external port 115, RF circuitry 105, audio circuitry 109, headphone jack 107, microphone 108, motion sensor array 158, supplementary light source for optical sensors 157, an input/output (I/O) subsystem 104, display controller 150, display(s) 109, light sensor(s) controller 153, light sensor(s) 156, camera controller 152, camera(s) 165, optical sensor(s) controller 151, optical sensor(s) 164, and other input or output control devices 110 and a controller for other input or output devices 154. These components communicate over one or more communication buses, signal lines, and the like 102. The components which have just been discussed may be solely implemented in hardware such as on a printed circuit board, or may be a combination of hardware and software, including one or more signal processing or specific integrated circuits.

RF circuitry 105 can communicate with networks including but not limited to, the Internet (also referred to as the World Wide Web), an intranet, wireless network(s), a wireless local area network (LAN), a metropolitan network (MAN), and other devices via wireless communication(s). The wireless communications may use but are not limited to any one or a combination of the following standards, technologies, or protocols: Bluetooth (registered trademark), wireless fidelity (Wi-Fi) (non-limiting examples: IEEE 802.11a, IEEE 802.11b, IEEE 802.11g and or IEEE 802.11n), near field communications (NFC), email protocols (non-limiting examples: internet message access protocol (IMAP) and or post office protocol (POP)), instant messaging (non-limiting examples: extensible messaging and presence protocol (XMPP) and or Short Message Service (SMS)), or any other communication protocol including communication protocols which have not yet been invented as of the filing date of this disclosure.

RF circuitry 105, uses Bluetooth (registered trademark) to allow other devices, such as Bluetooth (registered trademark) enabled handsets to connect to the device as an other input control device, to interact with and control the content shown on display(s) 109. Other non limiting examples of devices that can connect to this device via Bluetooth to control content shown on display(s) 109 includes VR gloves or fitness trackers. In some embodiments this may occur using Bluetooth (registered trademark) tethering. Through this connection, the Bluetooth (registered trademark) device which is connected to Dual HMD and VR Device 100 gains access to the device's user input, control, or interaction methods and sensors or modules which can be used to control the device, Dual HMD and VR Device 100.

Memory 101 contains various example modules, which contain various software(s) and instruction(s) such as the device's Operating System 116, Graphics Module 143, HMD Module 125, GUI Module 117, Camera Feed Module 119, Image Processing Module 120, Virtual Reality Module 126, Launcher Module 204, and Stored VR Game(s) or World(s) Module 145. Memory 101 contains various example modules which contain various software(s) or instruction(s) which may work in conjunction with hardware components to provide various means of allowing the user to interact with or enter data into the device, Dual HMD and VR Device 100, such as text input module 121, iris control module 122, and voice recognition module 123.

Memory 101 contains Real Life VR Module 127, Stored Real Life Virtual World(s) Module 147, and Real Life Virtual World Creator Module 128. These items will be described within this disclosure, as they are included with in aspects of the invention.

To interact with the Dual HMD and VR Device 100, including the application which is about to be described, the user can use voice recognition, iris movements, button presses, or any other suitable method to control an on screen cursor. It should be obvious to one skilled in the art that many methods of controlling any device, whether it is a VR Device, HMD Device, Dual HMD and VR Device or any device which can provide an immersive experince 100 exist and therefore this method of controlling both the non limiting example device (Dual HMD and VR Device 100) and the application which is about to be described, is non limiting. Thus, embodiments may exist which do not include a cursor and which are controlled differently then what is described within this disclosure, but carries out the same functions.

Again, it should be reiterated that the device, Dual HMD and VR Device 100, is used within this disclosure to serve as a non limiting example of a device that this application can be used on. This application can be used with any device which provides an immersive experience. It should be obvious to one skilled in the art that many devices, currently existing and to be invented after the filing date of this disclosure, will be suitable for usage with this application.

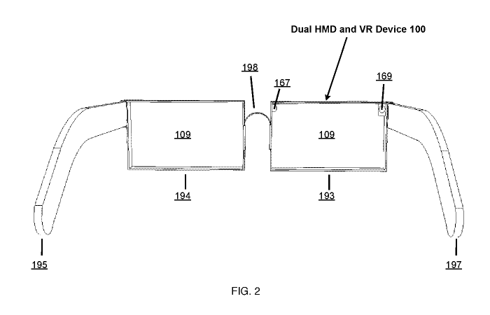

For the sake of saving room on the drawling sheets, only one screen of Dual HMD and VR Device 100 is shown. As shown in FIG. 2 Dual HMD and VR Device 100 has two screens. It will be understood that in any drawling beyond this point, only one screen is shown because the exact same thing which is being shown on the screen that is shown, is also shown on the screen that is not shown. As shown in FIG. 2, Dual HMD and VR Device 100 comprises case 195 and case 197 which rest on the user's ears and head as the user wears the device. Case 197 and case 197 also contain control logic and other hardware and software components that comprise Dual HMD and VR Device 100, which were discussed earlier within this disclosure and were illustrated on the included block diagram in FIG. 1. Case 194 and case 193 rest in front of the eyes of the user when the device is worn, and contain display(s) 109 as previously mentioned. Case 193 contains optical sensor 169 and supplementary light source for optical sensor(s) 167, which along with the software included on Dual HMD and VR Device 100 allow the user to be able to through the movements of the their eyes, to control the device and content shown on display(s) 109. Case 198 rests on the user's nose while the device is worn. Case 198 comprises nose pads and connects case 193 and case 194. Case 198 may contain wires, control logic, or hardware and or software components that comprise Dual HMD and VR Device 100 , which were discussed earlier within this disclosure and were illustrated on the included block diagram in FIG. 1.

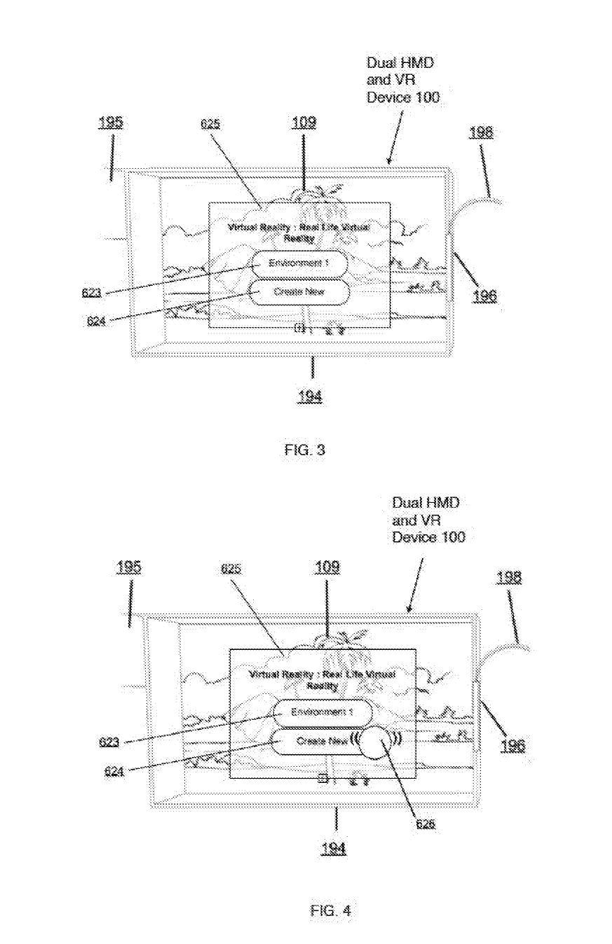

As shown in, FIG. 3, when this application is launched a listing of the Real Life Virtual Reality environments which are available to be experienced by the user, are listed within window or dialog box 625, either as a result of the user creating Real Life Virtual Reality environment(s) with the Dual HMD and VR Device 100.

Real Life Virtual Reality environments are stored within Stored Real Life Virtual World(s) Module 147 which exists within Applications 135 which is stored within Memory 101. As shown in FIG. 3, Real Life Virtual Reality Creator button 441 exists and when interacted with, the user can create a Real Life Virtual Reality world.

The user can use any suitable method to select any one of the listed Real Life Virtual Reality worlds to access it or to select the button which allows the user to create a Real Life Virtual Reality World.

Now there will be a discussion regarding how a can use this application to create a Real Life Virtual Reality World.

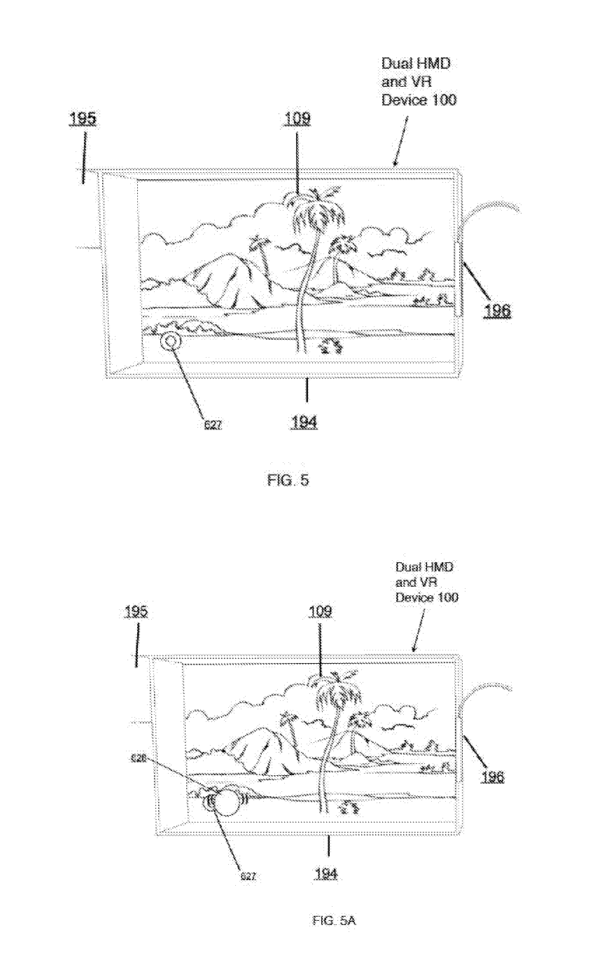

As shown in FIG. 4 in a non limiting example, by using the function of the speciality application for handset 171 the user uses the cursor 626 to select Real Life Virtual Reality Creator button 624. When Real Life Virtual Reality Creator button 624 is interacted with, Real Life Virtual World Creator. Module 128 is launched. Real Life Virtual World Creator Module 128 contains software or instructions to turn camera(s) 109 on, to activate Camera Feed Module 119 and to display the resulting camera feed on display(s) 109 as shown in FIG. 5. A record button 627 appears on screen, on top of the camera feed. The user can use any one of the aforementioned user input, control, or interaction methods to interact with record button 627. In some embodiments, a button such as button 627 may not appear, but the user any suitable user input, control, or interaction methods.

In a non limiting example, as shown in FIG. 5A by using the cursor on display(s) 109, the user selects record button 627. As a result of the user selecting record button 627, software or instructions with in Real Life Virtual World Creator Module 128 begin to record the live video feed that results from each camera that is shown on display(s) 109, to record data on their position (for example: data indicating which video feed is captured from the left or right camera) and associate that data with the video files or files which are a result of recording the video feed(s), and instructions to save these captured videos within Stored Real Life Virtual World(s) Module 147 within Applications 135 which is within Memory 101.

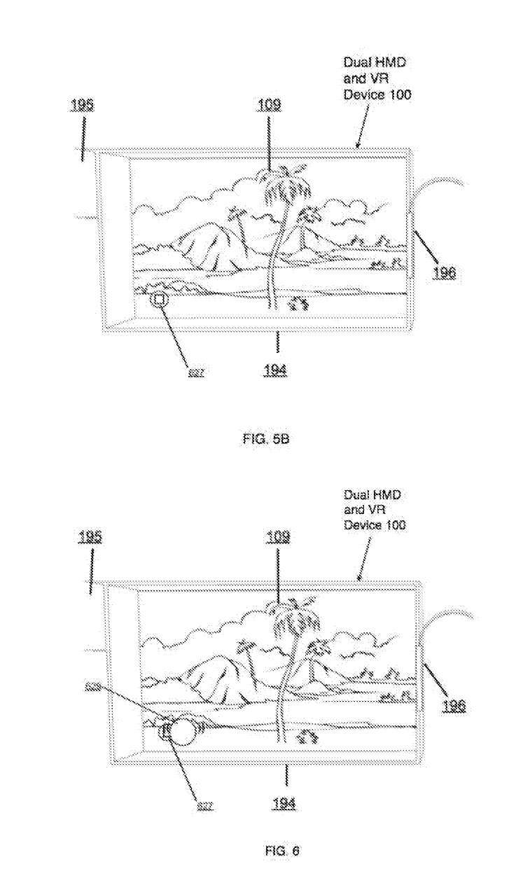

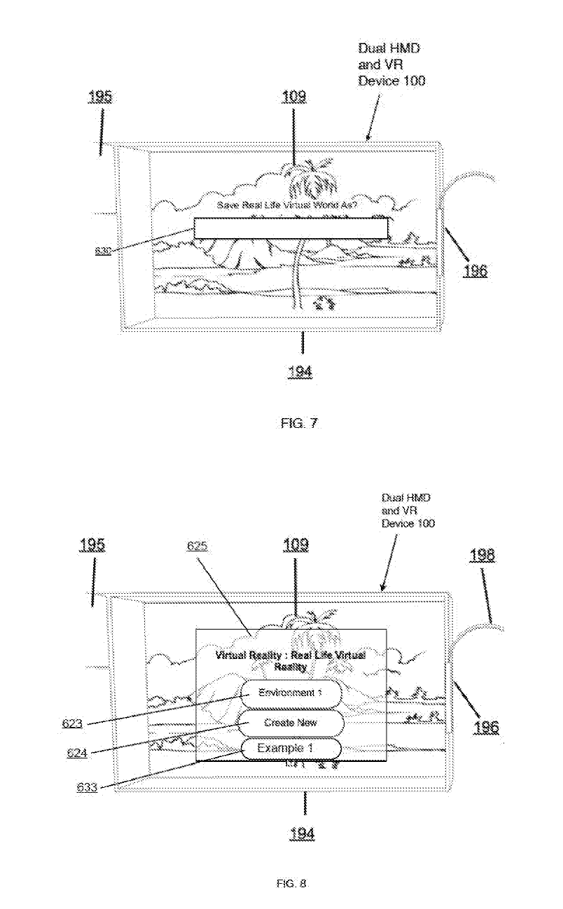

When the user is finished creating their real life virtual world environment, to stop recording, the user can use any one of the aforementioned user input, control, or interaction methods to interact with record button 627, as record button 627 displays a stop icon instead of a record icon oIice recording is initiated by the user, as shown in FIG. 5B. In a non limiting example, as shown in FIG. 6, the user positions the cursor over record button 627 and selects record button 627. As a result, the recording of the Real Life Virtual World stops and the Real Life Virtual World is saved in Stored Real Life Virtual World(s) Module 147 within Applications 135 within Memory 101. In some embodiments, as shown in FIG. 7 the user is asked to give the Real Life Virtual World a title.

In some embodiments, the user may not be asked to do this. In some embodiments, after the user is done creating the real life virtual world environment, they will have the option to edit the video or video(s) which make up the real life virtual world environment with tools similar to those that exist in video editing software(s). Non limiting examples of these tools include: cropping video, editing the timing of a video, changing the appearance of a video (example: color or filter options), editing audio levels, editing a video's position, adding audio tracks, and the like.

In some embodiments, immediately after the user is done recording the real life virtual world environment, the user may be able to immediately launch the Real Life Virtual World they've just created, send it to others, share it over the internet, onto a server, onto a cloud, within an application, or the like. In some embodiments, the real life virtual world may not even be saved to a device, such as Dual HMD and VR Device 100, it may be saved directly onto a cloud, server, application, or other storage device in which the device may connect to or be connected to.

In some embodiments, the two examples given of what can occur in alternate embodiments may be used in combination with each other. In a non limiting example, the user may, in some embodiments, be able to edit the real life virtual world environment by using the video editing tools described above and then can immediately send or share the real life virtual world environment with others.

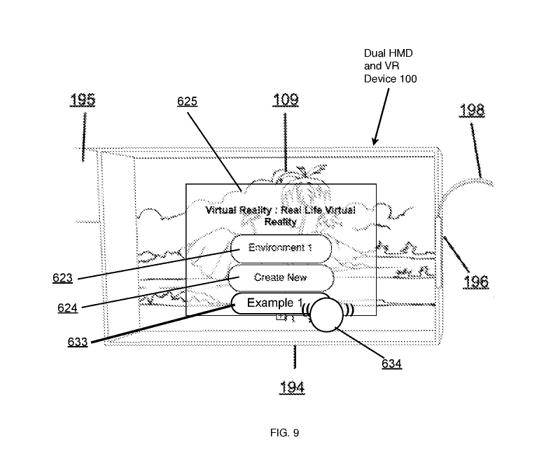

The Real Life Virtual World environment that the user has just created 633 can now be accessed from the list of all Real Life Virtual Worlds which are shown in dialog box 625 as shown in FIG. 8 which appears when the user launches the application. The user, can use any suitable method to select the Real Life Virtual World they just created to launch it. In a non limiting example, as shown in FIG. 9, the user positions the cursor 634 over the real life virtual world just created 633, and selects the real life virtual world just created 633.

As a result, the selected Real Life Virtual World launches. Software and instructions contained within Real Life VR Module 127 which execute when a real life virtual world is launched include: instructions to play the videos which make up the real life virtual world at the exact position they were shot at, instructions to play all of the videos that make up the real life virtual world simultaneously, and in some embodiments instructions to allow the user to use any of the aforementioned user control or interaction methods to control aspects of these real life virtual experiences.

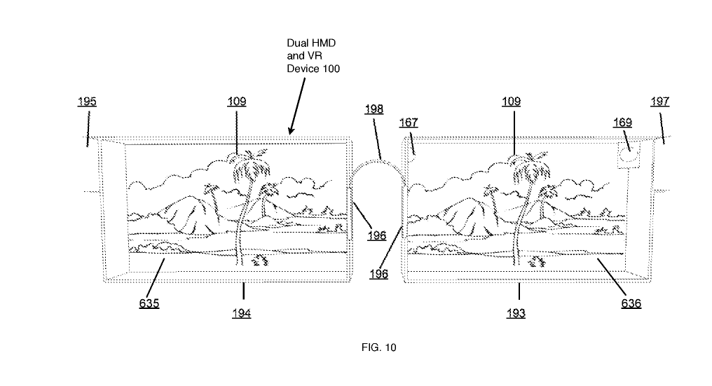

In a non limiting example, after the user launches a real life virtual world environment, in a two camera and two display embodiment of Dual HMD and VR Device 100, software or instructions within Real Life virtual Reality module 127 uses the previously collected data to position the video feed which was taken from the user's left side of the device, plays on the display in front of the user's left eye. The video taken from the user's right side of the device, plays on the display in front of the user's right eye. This is shown in FIG. 10. 635 on display(s) 109 is the video that was captured from the user's left side of the device, playing on the display of display(s) 109 which rests in front of the user's left eye. 636 on display(s) 109 is the video that was captured from the user's right side of the device playing on the display of display(s) 109 which rests in front of the user's right eye. As previously stated, these videos play simultaneously.

It should be noted, that accurately playing the videos in the position that they were shot at, is to make sure the videos are accurately reproduced, so that when they are shown on the display or displays, the user's brain can accurately merge or overlap the video feeds into one scene. The camera or cameras on the front of the device are already positioned accurately so they see the same sets of image signals at slightly different angles, ensuring that when the eyes transmit the image signals to the brain a flawless overlap or merge to create one scene will occur. Within the software, the video feeds must be shown on the correct displays so that the scenes can merge without issues. For example, in a two camera embodiment, the video feed that was shot with the left camera would be shown on the left display and the video feed that was shot with the right camera would be shown on the right display, creating a seamless real life virtual world experience with no viewing issues.

Each eye sees similar yet different views of what the human is looking at because human vision is binocular, meaning that each eye sees the same thing when looking at something to a certain degree. The visual field or field of view of each eye independently is approximately 120 degrees, with at least half of those degrees being dedicated to the peripheral vision. This means that 60 degrees of each eye are dedicated to binocular vision. Each eye transmits two similar yet different positioned sets of image signals to the brain which merges them into one image, creating our field of view.

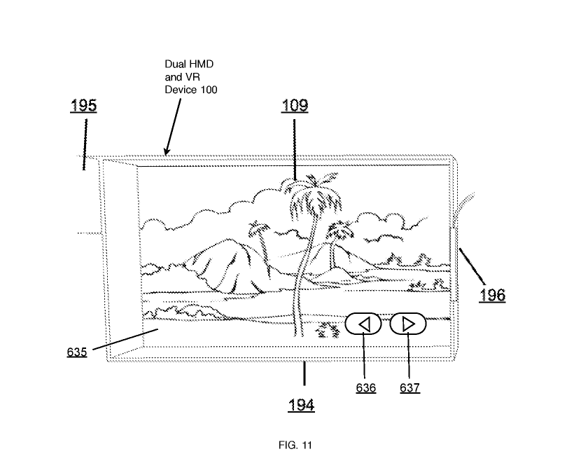

In another non limiting example, FIG. 11 shows that in some embodiments, the user can control aspects of these real life virtual world experiences. In FIG. 11, if the user interacts with buttons 636 and 637, the rate of speed or playback of the real life virtual world environment can be either slowed down or sped up. It should be obvious to one skilled in the art that many alternate embodiments that allow the user to control aspects of these real life virtual world experiences can exist.

It should also be noted that very little movement can happen within real life virtual world experiences which are created using only one or two cameras, because the viewing area is not encompassing the user, and thus movements are very limited. In some real life virtual world experiences created by only using one or two cameras, a user may be able to move a small bit in these real life virtual world experiences by using a suitable user input or interaction method, but may only be able to see the real life virtual world experience from a slightly different angle.

A discussion will now occur regarding another aspect of the invention, an expansion pack 638 which has additional cameras which allows the user to create Real Life Virtual Worlds that can extend up to 360 degrees. The real life virtual worlds creating this expansion pack can partially surround the user, or fully surround the user (360 degrees) depending on how many cameras are included with the expansion pack.

Real life virtual worlds created using this method allow the user to be able to move around, changing what they see in their field of view while immersed in these environments. Thus, the experience which is offered in Real Life Virtual Worlds is extended due to this expansion pack. This expansion pack and associated hardware and software components will now be described.

Attention is now directed completely towards the block diagram shown in FIG. 12. The block diagram shown in FIG. 12 is the block diagram for Expansion pack 638. The block diagram shown in FIG. 12 illustrates that one or more additional camera(s) 641 can be included on or within expansion pack 638.

This expansion pack contains one or more microprocessing unit(s) 639 and an I/O subsystem 640, which allows camera(s) 641 to be connected to expansion pack 638 as well as removable computer readable storage media 642. Non limiting examples of removable computer readable storage media includes memory cards, such as SD cards. In some embodiments, the computer readable storage media may not be removable. This expansion pack, as shown in FIG. 12, also contains a peripherals interface 645, which contains external port connector 644, and power system 643.

Examples of external port connector 644 include but are not limited to: Micro On-The-Go (OTG) Universal Serial Bus (USB), Micro Universal Serial Bus (USB), Universal Serial Bus (USB), other external port technologies that allow the transfer of data, connection of other devices, and charging or powering of a handset, or other suitable technology(s) that have not yet been invented as of the filing date of this disclosure. The external port connector 644 of expansion pack 638 connects to the external port of Dual HMD and VR Device 100. When this connection is established, the sensor or expansion pack connects to the peripheral interface included within Dual HMD and VR Device 100.

In some embodiments, expansion pack 638 contains RF circuitry. RF circuitry, receives and sends electromagnetic signals, converts electronic signals to and from electromagnetic signals, communicates with communications networks, and communicates with other communications devices via these signals. RF circuitry includes known circuitry for performing these functions, which may include but is not limited to antenna(s) or an antenna system, amplifier(s), a tuner, oscillator(s), RF transceiver, a digital signal processor, memory, and the like.

RF circuitry can communicate with networks including but not limited to, the Internet (also referred to as the World Wide Web), an intranet, wireless network(s), a wireless local area network (LAN), a metropolitan network (MAN), and other devices via wireless communication(s). The wireless communications may use but are not limited to any one or a combination of the following standards, technologies, or protocols: Bluetooth (registered trademark), wireless fidelity (Wi-Fi) (non-limiting examples: IEEE 802.11a, IEEE 802.11b, IEEE 802.11g and or IEEE 802.11near field communications (NFC), email protocols (non-limiting examples: internet message access protocol (IMAP) and or post office protocol (POP)), instant messaging (non-limiting examples: extensible messaging and presence protocol (XMPP) and or Short Message Service (SMS)), or any other communication protocol including communication protocols which have not yet been invented as of the filing date of this disclosure.

In these embodiments, RF circuitry would be utilized to establish a bi-directional communication link between the VR Device, HMD Device, Dual HMD and VR Device or any device which can provide an immersive experience that expansion pack 628 is being used with, for the transfer of data. In a non limiting example, the VR Device, HMD Device, Dual HMD and VR Device or any device which can provide an immersive experience which is being used with expansion pack 628 may be connected to each other via Bluetooth (registered trademark), thus creating a bi-directional communication link.

In the examples below, expansion pack 628 is connected to Dual HMD and VR Device 100 via it's external port connector connecting to the external port of Dual HMD and VR Device 100.

Power system 643, as shown in FIG. 12 allows the expansion pack 638 to be powered. Power system 643, which may include a power management system, a single power source or more than one power source (non limiting examples: battery, battery(s), recharging system, AC (alternating current), power converter or inverter), or other hardware components that attribute to power generation and management in wearable multifunction devices.

These components communicate over one or more communication buses, signal lines, and the like. In some embodiments all of or a combination of these items may be implemented on a single chip.

As shown in FIG. 13, is an overhead view of expansion pack 638. Expansion pack 638 is a shape which contours to fit around the user's head. The two straight sides 646 and 647 respectively, measure anywhere from two to six inches in length. The circular contour 648 of the expansion pack measures anywhere from two to eight inches from the beginning of the circular contour to the end of the circular contour.

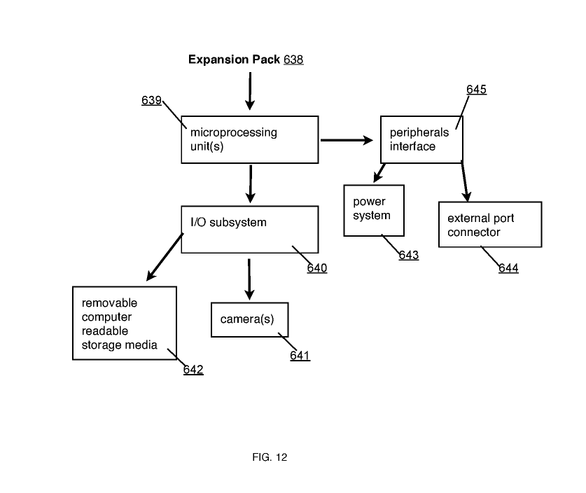

FIG. 14 is a left side view of expansion pack 638. 649 and 653 are camera(s). In this embodiment, the left side of the expansion pack 638 has two cameras.

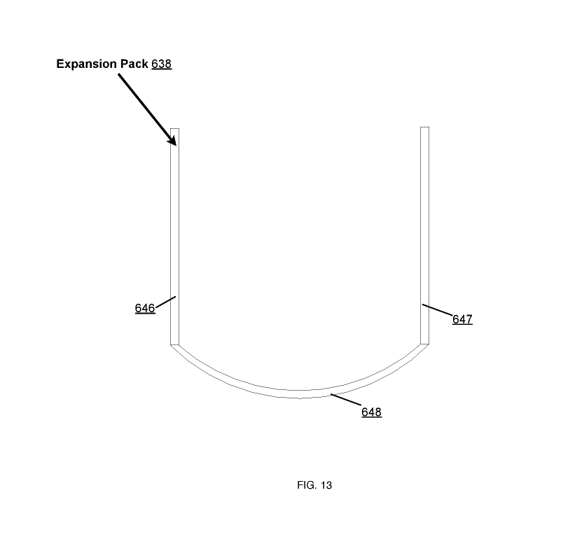

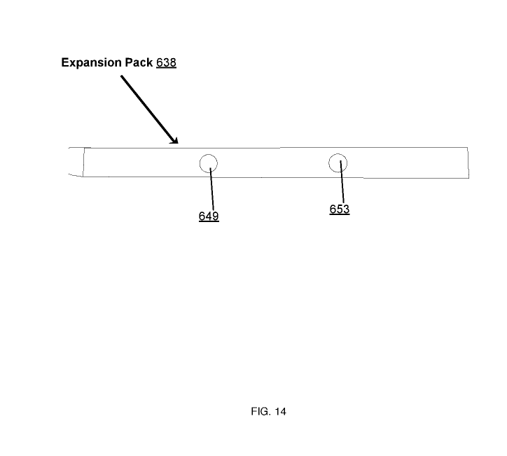

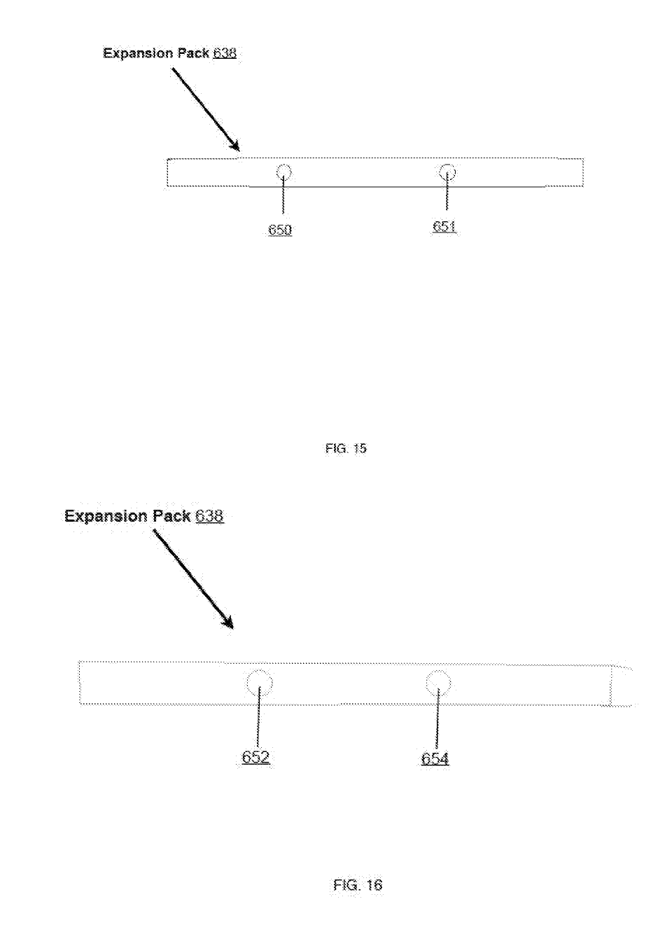

FIG. 15 is a back side view, along the circular contouring of expansion pack 638. 650 and 651 are camera(s). In this embodiment, the back side of the expansion pack, has two cameras.

FIG. 16 is a right side view of expansion pack 638. 652 and 654 are camera(s). In this embodiment, the right side of the expansion pack 638 has two cameras.

In this embodiment, expansion pack has six cameras. As previously stated, in some embodiments expansion pack 638 may have more or less cameras than what is shown in this non limiting embodiment. It should be obvious to one skilled in the art that many camera combinations are possible.

FIG. 17 is an angled inside view of the left side of the expansion pack 638. This view shows that in this embodiment, the expansion pack is custom molded to fit around or clip into Dual HMD and VR Device 100. It should be obvious to one skilled in the art that other embodiments may exist of Dual HMD and VR Device 100 that do not clip onto the device and that many possible embodiments involving many possible materials are possible. In some embodiments, expansion pack 628 may be adjustable to accommodate different shaped devices, using any method that exists at the time of the filing of this disclosure or any method which may be invented beyond the filing date of this disclosure which is appropriate for expansion pack 628 to be adjustable.

FIG. 18 is an angled inside view of the right side of the expansion pack 638, illustrating that this side of the expansion pack is also custom molded to fit around or clip into Dual HMD and VR Device 100.

Cameras 649, 650, 651, 652, and 653 are positioned so that the field of view from each camera intersects slightly with each other, and then the camera's nearest the camera's included on Dual HMD and VR Device 100 are the correct measure to ensure that their horizontal field of view intersects slightly, so when the video from both the camera's on Dual HMD and VR Device 100 as well as the video from the cameras on expansion pack 638 are stitched together to make one scene, it is

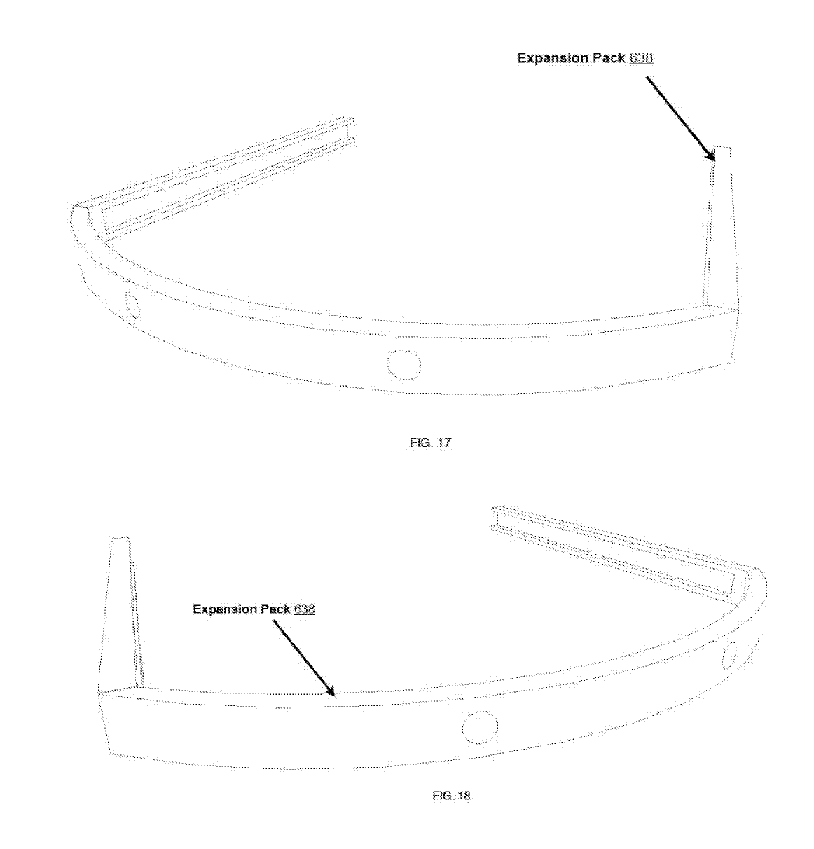

The overhead view illustrated in FIG. 19, illustrates the expansion pack 638 on the user's head and the field of view of each camera, showing how the field of view of each camera intersects.

In this embodiment, the two cameras on Dual HMD and VR Device 100 which are represented by circle 654 and 655 in FIG. 19 each have roughly a 60 to 65 degree field of view horizontally. Thus, they have a combined field of view of 120 degrees. Their field of view is represented by the area between lines 672 and 673 in FIG. 19. The cameras on the left side of expansion pack 638, cameras 649 and 653, are represented by circle 656 and 657 in FIG. 19 each have roughly a 60 to 65 degree field of view horizontally. Thus, they have a combined field of view of 120 degrees. Their field of view is represented by by the area between lines 678 and 679 in FIG. 19.

The cameras on the back side of expansion pack 638, cameras 650 and 651, are represented by circle 658 and 659 in FIG. 19 each have roughly a 60 to 65 degree field of view horizontally. Thus, they have a combined field of view of 120 degrees. Their field of view is represented by the area between lines 674 and 675 in FIG. 19.

The cameras on the right side of expansion pack 638, cameras 652 and 654, are represented by circle 670 and 671 in FIG. 19 each have roughly a 60 to 65 degree field of view horizontally. Thus, they have a combined field of view of 120 degrees. Their field of view is represented by the area between lines 677 and 676 in FIG. 19.

These camera's are also spaced 62-64 mm apart from each other, which is known as the average distance between both pupils in humans.

As illustrated by FIG. 19, the combined field of view of all of these cameras creates a large field of view which encompasses the user. In this embodiment, the cameras capture roughly 360 degrees of combined video, surrounding the user completely. Mathematically, adding the combined field of view of the cameras on Dual HMD and VR Device 100 (120) plus the combined field of view of the cameras on the left side of the expansion pack (120), plus the combined field of view of the cameras on the right side of the expansion pack (120) as well as the field of view of the camera's on the back of the expansion pack (120), the result is 480 degrees of video captured. The video captured, in an ideal embodiment, will exceed 360 degrees, or whatever measure of video the user hopes to capture, so that the overlap created by the fields of view including aspects of the fields of view in which they are positioned next to, allows for the videos which create the real life virtual world to be stitched together by software or instructions into one seamless scene of video without visual inconsistencies. It should be noted that the overlap caused by the fields of view can be any amount of degrees, as long as an overlap occurs.

In other embodiments, no stitching may be required as the angles of views from the cameras are positioned to intersect, thus the scene created by the overlap of the cameras may be flawless enough in some embodiments that stitching is not required.

This seamless scene of video will then be positioned via software or instructions so that the video which was taken using the camera(s) which are on Dual HMD and VR Device 100 will be positioned directly in front of the user's eyes on display(s) 109 when the real life virtual world environment launches and the methods used to control or interact with these real life virtual world environments will make the user feel as though these virtual worlds are surrounding them. This process will now be described.

When this attachment, is connected to Dual HMD and VR Device 100, and the user follows the procedure outlined above to begin creating a Real Life Virtual World Environment, Real Life Virtual World Creator Module 128 contains software or instructions to detect if expansion pack 638 is connected to Dual HMD and VR Device 100.

In a non limiting example, as shown in FIG. 20 the user drags cursor 681 over record button 680 to select it. When the user selects record button 680, since it has been detected that expansion pack 638 is connected to Dual HMD and VR Device 100, in response Real Life Virtual World Creator Module 128 contains software or instructions to communicate with software or instructions which are stored in microprocessing unit(s) 639 that are included within expansion pack 638.

The software or instructions included within expansion pack 638 that are executed on the microprocessing unit(s) 639 that are included within expansion pack 638 include instructions to capture a real time video feed from the multiple cameras which are included within expansion pack 638 in unison with the real time video feed which is being acquired from the camera(s) 165 on Dual HMD and VR Device 100, instructions to gather data about the position that the video is shot in either based off of the positioning of the cameras, instructions to save the video that is captured from the cameras on the expansion pack onto the removable computer storage media located within expansion pack 638, instructions for the expansion pack 638 to communicate with and work in conjunction with the aforementioned programs stored in Dual HMD and VR Device 100 to take the video that is stored in Dual HMD and VR Device 100 and in the computer removable storage media of expansion pack 642 and use the data on the positions of each video to stitch it into one seamless scene of video while retaining data on the position of each individual video that is a part of the scene to then accurately stitch, if needed, the videos acquired to the left and right of the video that was taken from the camera(s) on Dual HMD and VR Device 100, and instructions for when a user chooses to view one of these worlds.

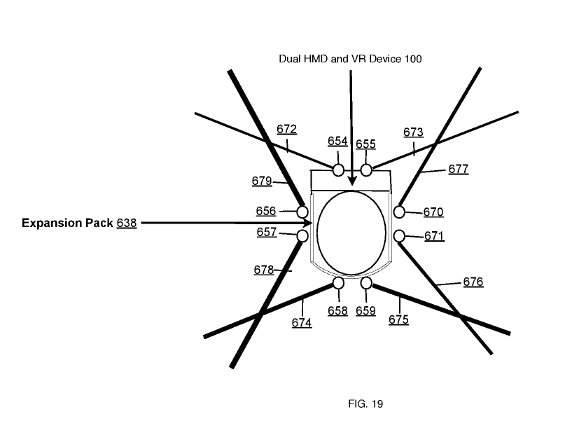

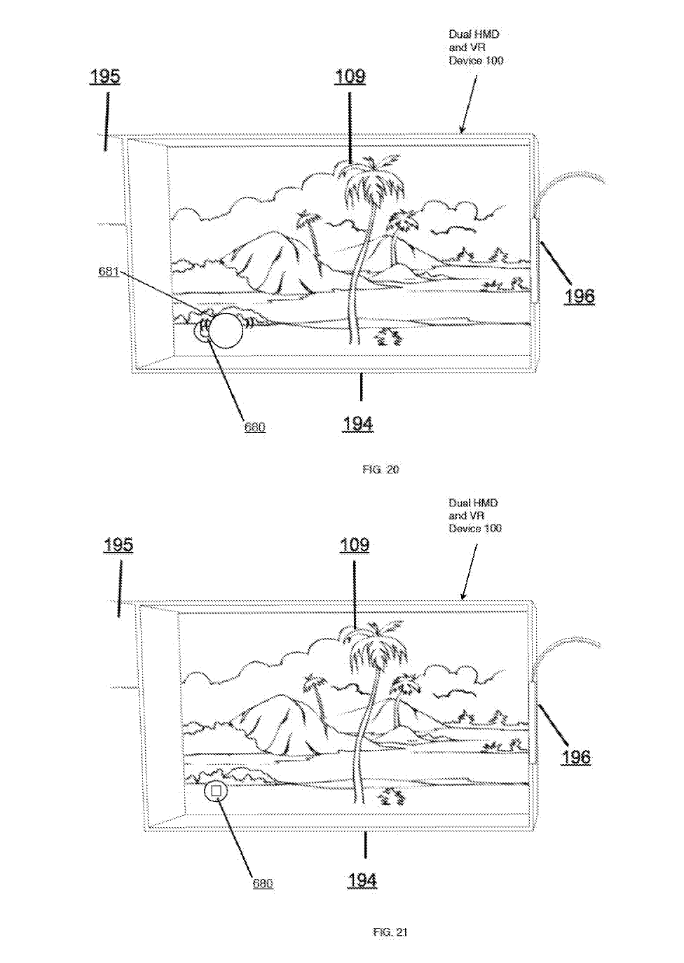

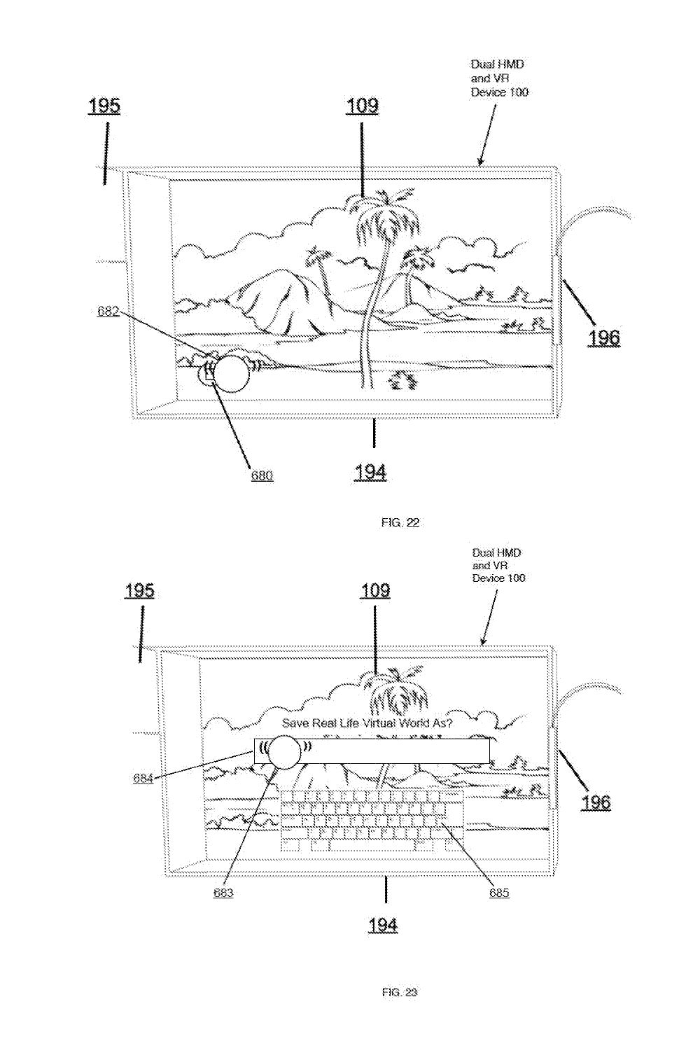

When the user is finished creating their real life virtual world environment, to stop recording, the user can use any suitable method to select record button 680, as record button 680 displays a stop icon instead of a record icon once recording is initiated by the user, as shown in FIG. 21. In a non limiting example, as shown in FIG. 22 the user uses any suitable method to use cursor 682 to select record button 680. As a result, the recording of the Real Life Virtual World stops and the Real Life Virtual World is saved in Stored Real Life Virtual World(s) Module 147 within Applications 135 within Memory 101.

As shown in FIG. 23 the user is asked to give the Real Life Virtual World a title. The user inputs a title in text area 684 as shown in FIG. 24 and the real life virtual world is saved with this title. The Real Life Virtual World Environment and the video files which it is made up of are saved completely on Dual HMD and VR Device 100. In some embodiments some of files are saved on Dual HMD and VR Device 100 and some of the files are saved on expansion pack 638.

In some embodiments, the user may not be asked to give the Real Life Virtual World Environment a title. In some embodiments, after the user is done creating the real life virtual world environment, they will have the option to edit the video or video(s) which make up the real life virtual world environment with tools similar to those that exist in video editing software(s). Non limiting examples of these tools include: cropping video, editing the timing of a video, changing the appearance of a video (example: color or filter options), editing audio levels, editing a video's position, adding audio tracks, and the like. In some embodiments, while the Real Life Virtual World Environment is being saved, software or instructions may exist to automatically edit and adjust the video, such as cropping out unnecessary objects.

In some embodiments, immediately after the user is done recording the real life virtual world environment, the user may be able to immediately launch the Real Life Virtual World they've just created, send it to others, share it over the internet, onto a server, onto a cloud, within an application, or the like. In some embodiments, the real life virtual world may not even be saved to a device, such as Dual HMD and VR Device 100, it may be saved directly onto a cloud, server, application, or other storage device in which the device may be connected to.

In some embodiments, the examples given of what can occur in alternate embodiments may be used in combination with each other. In a non limiting example, the user may, in some embodiments, be able to edit the real life virtual world environment by using the video editing tools described above and then can immediately send or share the real life virtual world environment with others.

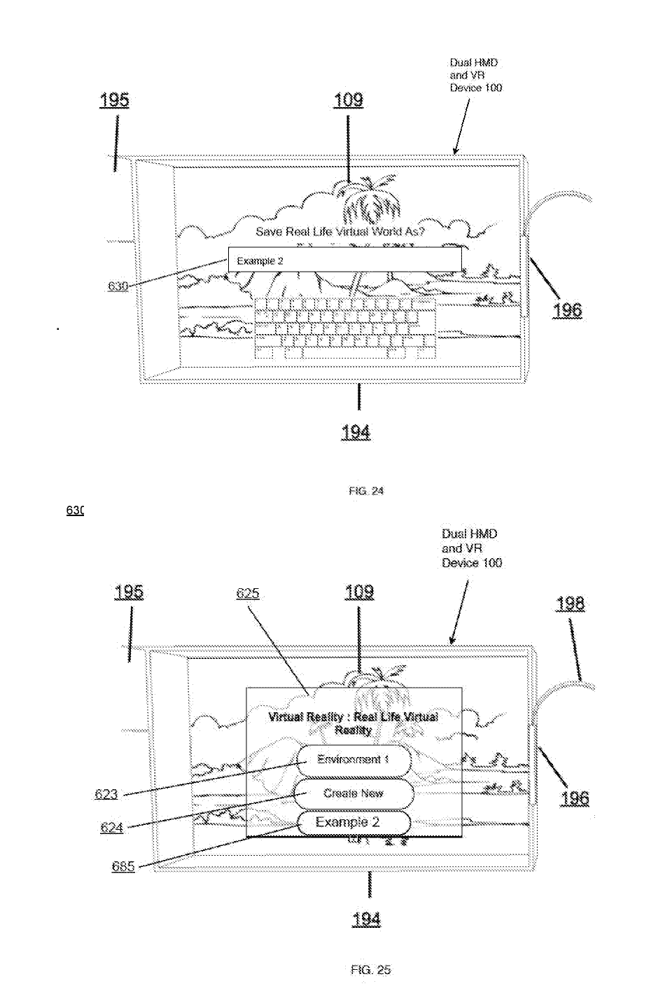

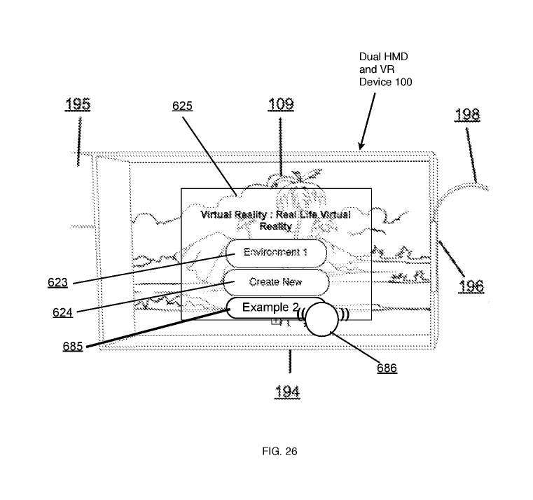

The Real Life Virtual World environment that the user has just created 685 can now be accessed from the list of all Real Life Virtual Worlds which are shown in dialog box 625 as shown in FIG. 25 which appears when the user enters the VR realm of the device and selects Real Life Virtual Reality, as previously described. The user, can use any suitable method to select the Real Life Virtual World they just created 685 to launch it. In a non limiting example, as shown in FIG. 26, the user uses a suitable method to position the cursor 686 over over the title of the Real life virtual world environment that was just created 685 to select it.

As a result, the selected Real Life Virtual World launches. Software or instructions within Real Life VR module 127 detects that the Real Life Virtual World environment which is launching was created with expansion pack 638. As a result of Real Life Virtual World Module 127 detecting that the Real Life Virtual World Environment was created with expansion pack 638, in response, the following software or instructions are executed: instructions to allow the real life virtual world experience to extend past the boundaries of the display or displays the user is looking through, instructions to position the stitched scene of video that makes up the real life virtual world environment so that the video which was acquired from the camera(s) 165 on Dual HMD and VR Device 100 is what the user sees on display(s) 109 when the real life virtual world environment launches, instructions to play each video that is stitched to make up the real life virtual world simultaneously, and instructions to allow the user to use any of the aforementioned control methods or user interactions with a connected handset to control these real life virtual world experiences so they can change their position to see a different angle within 360 degrees of the real life virtual world in order to see more of it or for example to control other functions such as but not limited to adjusting the speed or rate in which the real life virtual world experience is played at.

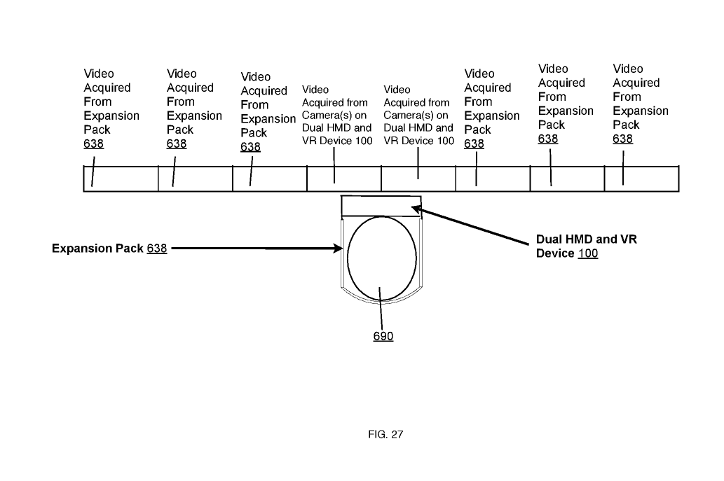

FIG. 27 shows, an overhead view of the stitched video scene which makes up the real life virtual world environment and the user. As shown in FIG. 27, the user is seeing, on display(s) 109, the video that was acquired from the cameras which are on Dual HMD and VR Device 100. In other embodiments, in which expansion pack 638 has more or less cameras than expansion pack 638 the stitched video scene which makes up the real life virtual world environment, may be a different shape or length than what is shown here.

The user, sees only a field of view of 100 to 120 degrees horizontally of these Real Life Virtual World Environments at one time, on display(s) 109. As shown in FIG. 27. All the videos which make up the Real Life Virtual World environment, are playing simultaneously, even the ones that cannot currently be seen. The user can see more of the real life virtual world that was created with expansion pack 638 by using any one of the aforementioned user input, control, or interaction methods. In some embodiments, this may be referred to as the user changing their field of view within the real life virtual world environment or what they see within their field of view within the real life virtual world environment. Various examples of how the user can use these aforementioned user input, control, or interaction methods to see more of real life virtual worlds will now be discussed. How this occurs will now be described by using both drawings that are overhead views and drawings that are what the user sees while wearing Dual HMD and VR Device 100 and performing these functions.

Software or instructions are contained with in Real Life Virtual Reality Module 127 so that the user can only turn the virtual world environment so they can see more of it similar to the software or instructions which are in place for Virtual Reality Virtual Worlds, that are similar to when humans turn or adjust their bodies in the direction that they want to face, the human has the option to turn their body in a circle, or within any direction that is within 360 degrees or less, while they are immersed in a Real Life Virtual World Environment. The only difference is, that instead of the user's position within the virtual world changing, the Real Life Virtual World moves around the user, changing what the user sees in their field of view. The position of the actual Real Life Virtual World Environment changes. Since the video is stitched accurately, and the camera(s) which captured the video are positioned so that there is overlap, as the user moves the real life virtual world environment to see more of it, they will feel like they are turning around in a circle, like we do in real life when we turn our bodies to immerse ourselves more deeply in the environment and to see more of it.

The user may use any suitable method to change the position of the real life virtual world environment to see more of it, allowing what can be seen in the user's field of view to change. Non limiting examples of these methods may include user interface button presses, physical presses of buttons located on the VR, HMD, or Dual VR and HMD device in which this expansion pack is being used in conjunction with, and voice recognition.

Software or instructions exist within Real Life Virtual Reality Module 127 to make the Real Life Virtual World move in the direction opposite of what the user is requesting the real life virtual world environment to move in. For example, if the user decided to push button 190, on Dual HMD and VR Device 100 shown in FIG. 28 to change the direction of the virtual world, since it is the forward most button, the virtual world environment would detect that the user would like to move the real life virtual world environment to the left. In response, it will actually move the real life virtual world environment to the right. This makes the user feel as though they are physically turning around in the environment, as they do when they change what they want to see in their field of view in real life, rather than feeling like the virtual world is moving around them which would feel very unnatural.

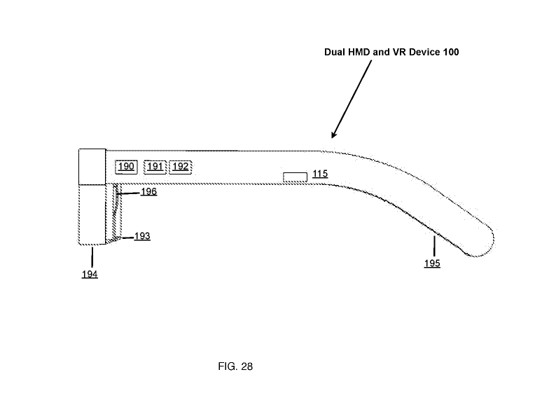

In this non limiting example, we will illustrate the user changing their position a full 360 degrees. FIG. 27 should be considered the starting position of the real life virtual world. It should be considered that the user, represented by 690, sees whatever is in the field of view of whatever video or video(s) Dual HMD and VR Device 100 is positioned in front of in FIG. 29 on display(s) 109. FIG. 29 is what the user sees in the starting position of the real life virtual world that was illustrated by FIG. 27.

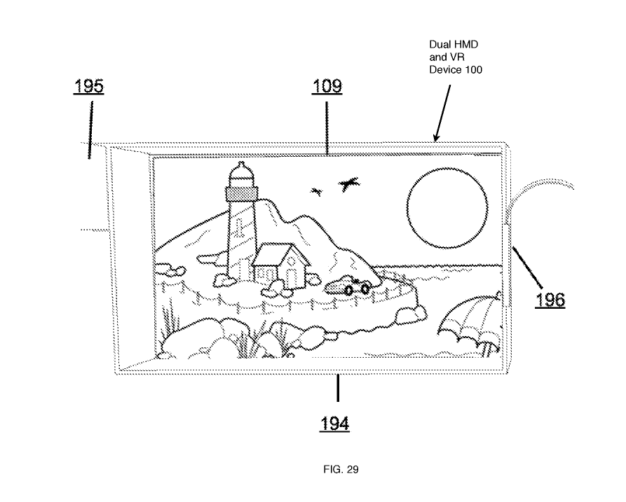

FIG. 30 and FIG. 31 show the user 900 pushing button 192 and in response, the position of the real life virtual world environment changes, thus what the user sees on display(s) 109 changes.

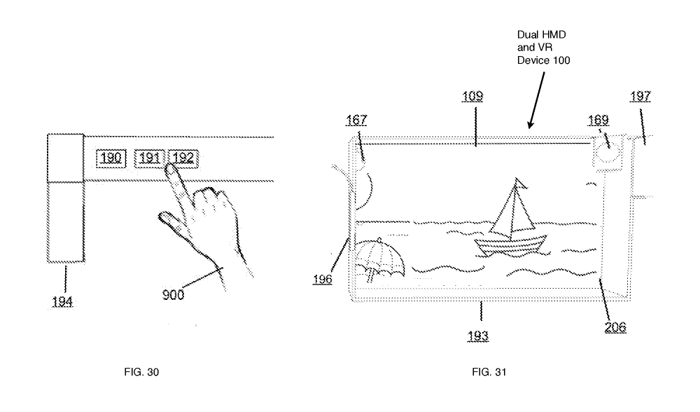

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 32, which is an overhead view of the user and the virtual world environment.

If the reader of this disclosure compares FIG. 32 to FIG. 27, the reader will notice that since the real life virtual world is moving to the left, the leftmost video acquired from expansion pack 638, is now positioned in FIG. 32 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

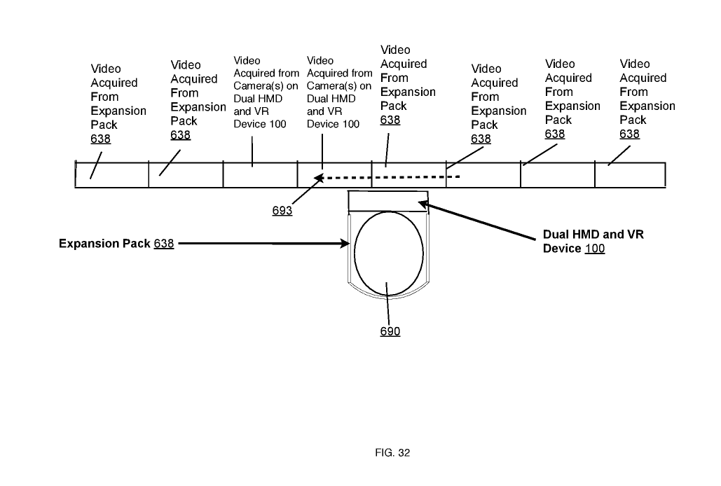

FIG. 33 and FIG. 34 show the user 900 pushing button 192 and in response, the position of the real life virtual world environment changes, thus what the user sees on display(s) 109 changes.

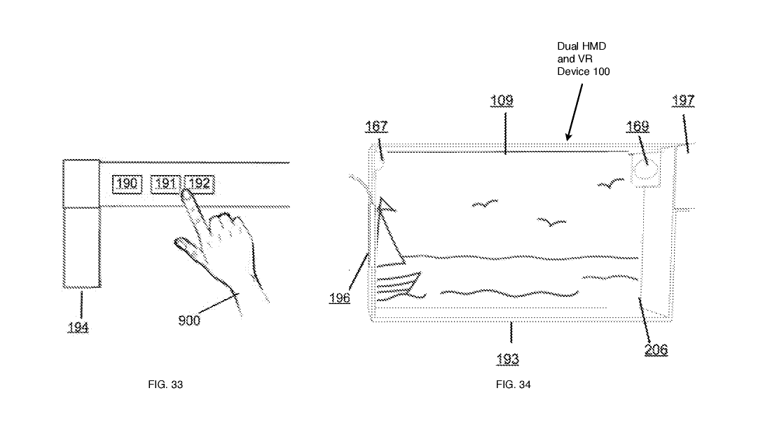

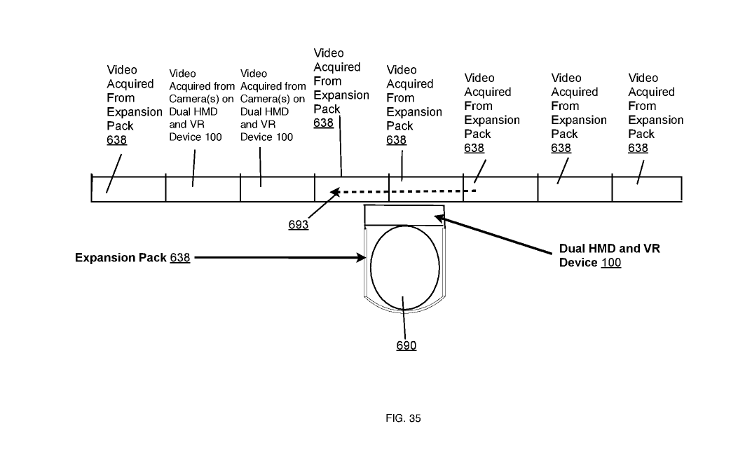

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 35, which is an overhead view of the user and the virtual world environment.

If the reader of this disclosure compares FIG. 35 to FIG. 32, the reader will notice that since the real life virtual world is moving to the left, the leftmost video acquired from expansion pack 638, is now positioned in FIG. 35 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

FIG. 36 and FIG. 37 show the user 900 pushing button 192 and in response, the position of the real life virtual world environment changes, thus what the user sees on display(s) 109 changes.

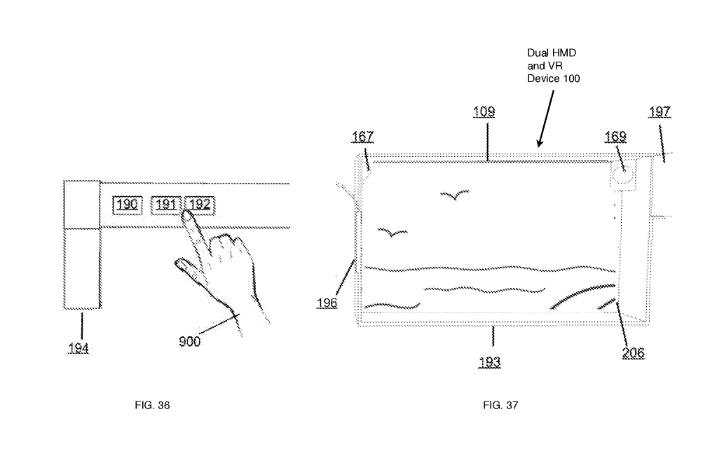

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 38, which is an overhead view of the user and the virtual world environment.

If the reader of this disclosure compares FIG. 38 to FIG. 35, the reader will notice that since the real life virtual world is moving to the left, the leftmost video acquired from expansion pack 638, is now positioned in FIG. 38 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

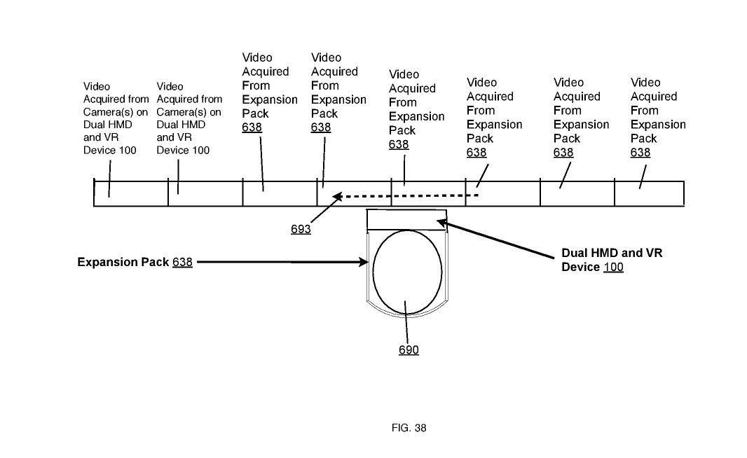

FIG. 39 and FIG. 40 show the user 900 pushing button 192 and in response, the position of the real life virtual world environment changes, thus what the user sees on display(s) 109 changes.

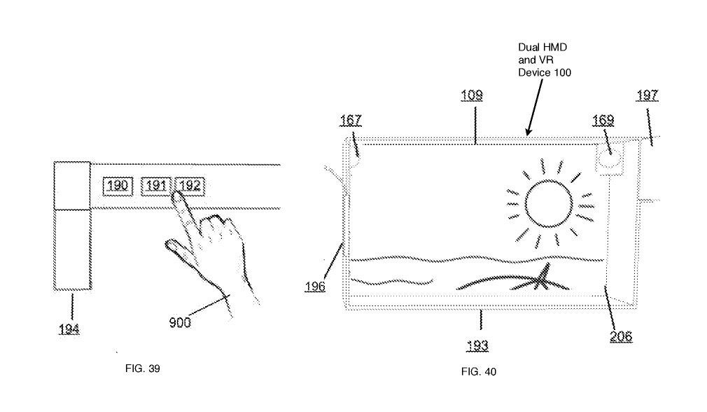

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 41, which is an overhead view of the user and the virtual world environment.

If the reader of this disclosure compares FIG. 41 to FIG. 38, the reader will notice that since the real life virtual world is moving to the left, the leftmost video acquired from expansion pack 638, is now positioned in FIG. 41 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

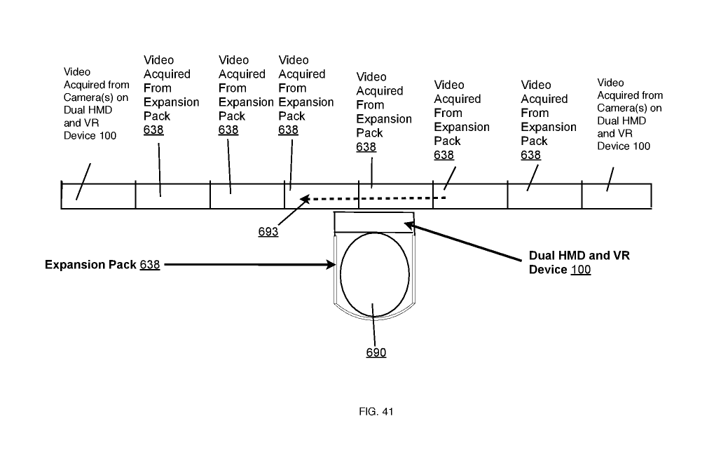

FIG. 42 and FIG. 43 show the user 900 pushing button 192 and in response, the position of the real life virtual world environment changes, thus what the user sees on display(s) 109 changes.

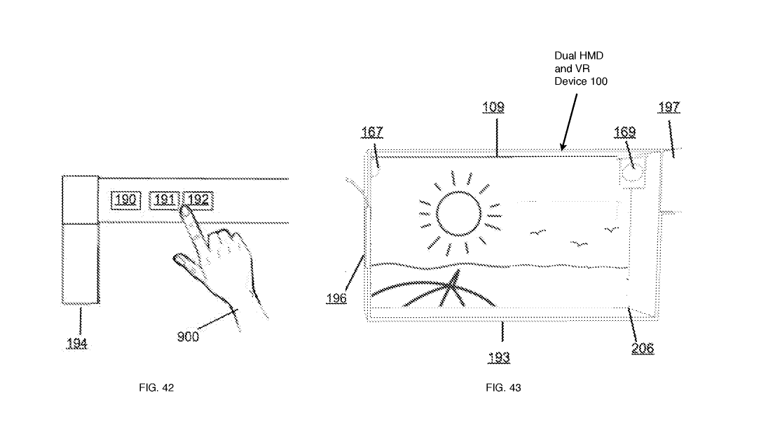

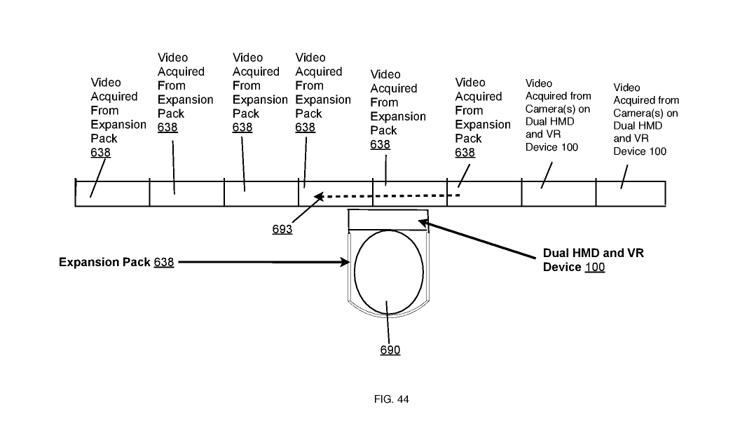

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 44, which is an overhead view of the user and the virtual world environment.

If the reader of this disclosure compares FIG. 44 to FIG. 41, the reader will notice that since the real life virtual world is moving to the left, the leftmost video acquired from expansion pack 638, is now positioned in FIG. 44 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

FIG. 45 and FIG. 46 show the user 900 pushing button 192 and in response, the position of the real life virtual world environment changes, thus what the user sees on display(s) 109 changes.

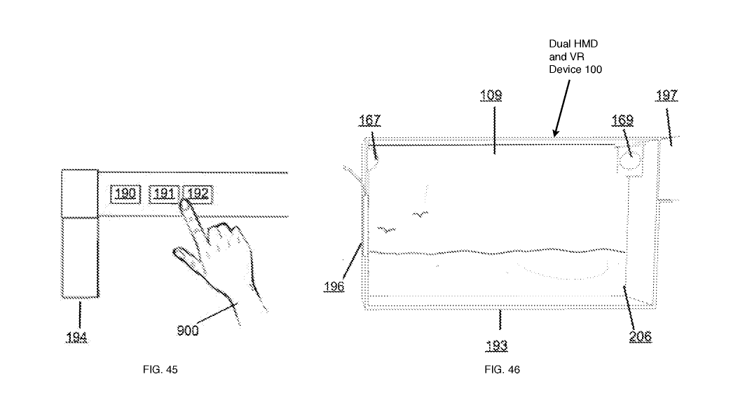

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 47, which is an overhead view of the user and the virtual world environment.

If the reader of this disclosure compares FIG. 47 to FIG. 44, the reader will notice that since the real life virtual world is moving to the left, the leftmost video acquired from expansion pack 638, is now positioned in FIG. 47 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

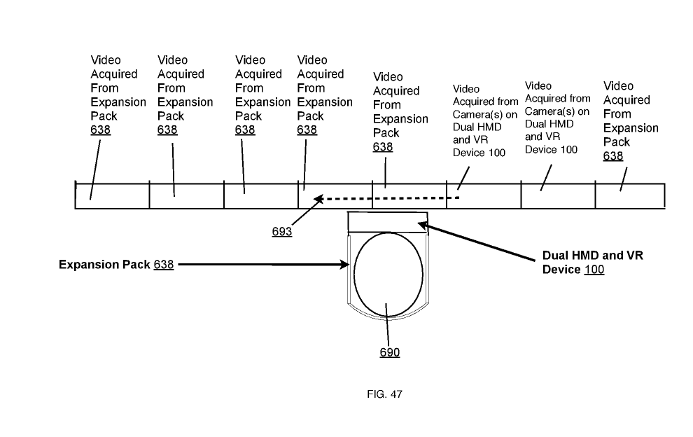

FIG. 48 and FIG. 49 show the user 900 pushing button 192 and in response, the position of the real life virtual world environment changes, thus what the user sees on display(s) 109 changes.

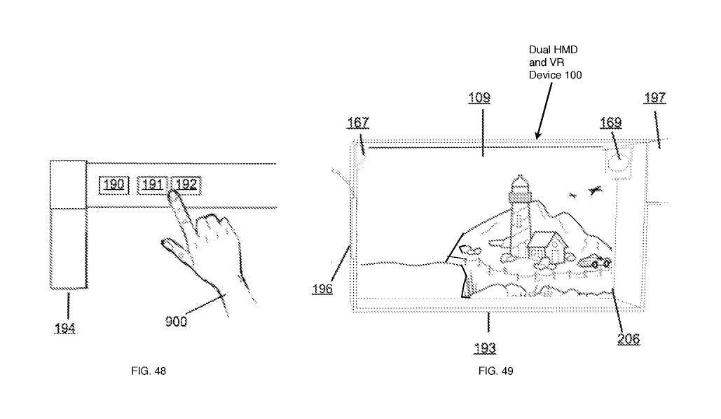

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 50, which is an overhead view of the user and the virtual world environment.

If the reader of this disclosure compares FIG. 50 to FIG. 47, the reader will notice that since the real life virtual world is moving to the left, the leftmost video acquired from expansion pack 638, is now positioned in FIG. 50 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

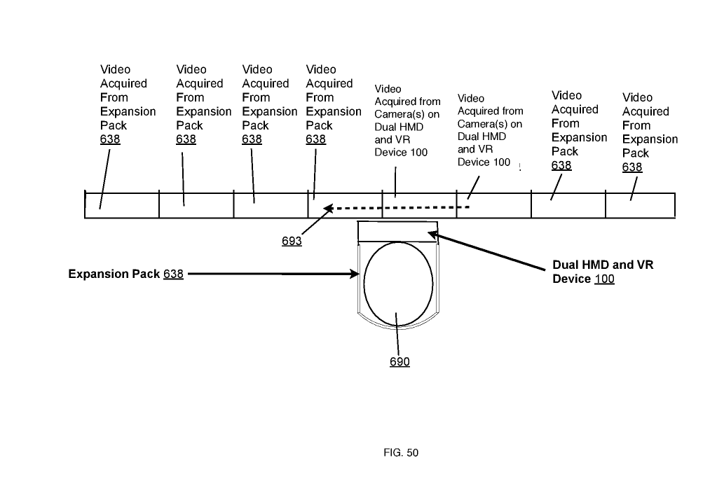

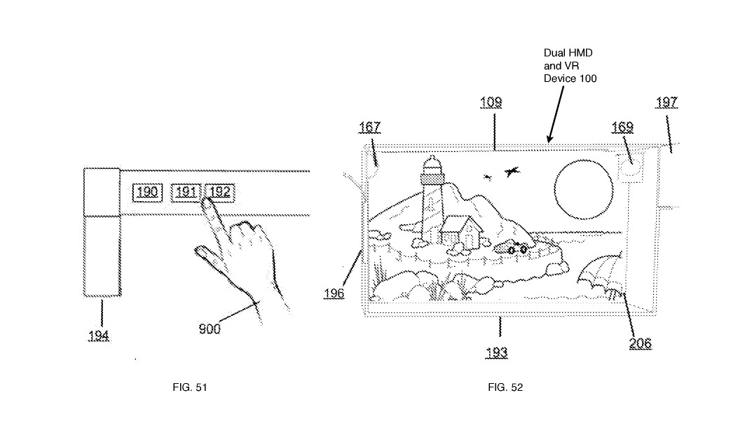

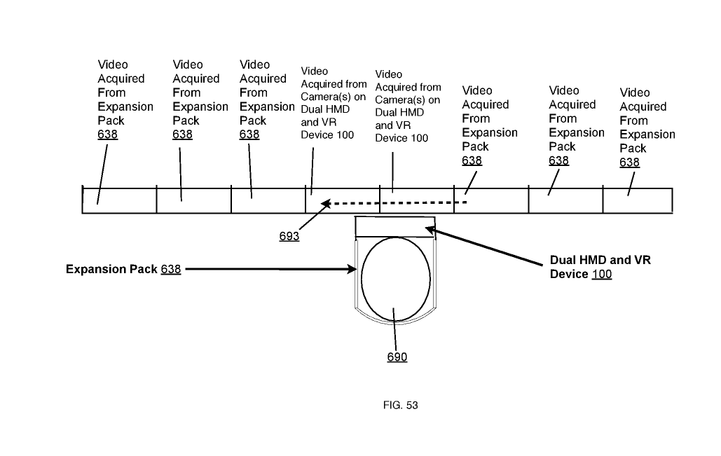

FIG. 51 and FIG. 52 show the user 900 pushing button 192 and in response, the position of the real life virtual world environment changes, thus what the user sees on display(s) 109 changes.

Since the user 900 decided to press button 192, to change the direction of the virtual world, which is the backward most button, the virtual world environment would detect that the user would like to move the real life virtual world environment to the right, thus the virtual world environment moves to the left, as illustrated by arrow 693 in front of user 690 in FIG. 53, which is an overhead view of the user and the virtual world environment.

If the reader of this disclosure compares FIG. 53 to FIG. 50, the reader will notice that since the real life virtual world is moving to the left, the leftmost video acquired from expansion pack 638, is now positioned in FIG. 53 on the rightmost side of the real life virtual world environment. This represents how via software or instructions, that when the real life virtual world environment moves to the left, the stitched video file which makes up the real life virtual world environment moves so that it remains continuous, meaning that the user can continue to press the button 192 as many times as they want to without the real life virtual world environment failing to display or making the user stop and move backwards, thus giving the user the illusion that the stitched video file which makes up the real life virtual world surrounds the user.

It should be realized that in this position the real life virtual world has returned to the point that it originated from and in the examples just provided, the user just turned the real life virtual world full 360 degrees, while in the physical world their body remained stationary.

When the real life virtual world is in the orientation the user wants it to be in, to stop moving, the user can stop pressing button 192. In some embodiments, this may occur by using any other suitable user input or interaction method. The example illustrated above where the real life virtual world turned 360 degrees, should be thought of as an example where the user continually pressed and held the button to turn 360 degrees without release. The real life virtual world environment can be turned by repeatedly pressing and releasing the button, but this experience will not be as smooth as pressing and holding the button. It should be obvious, that the user could also push button 190 or 191 as shown in FIG. 28 to move the real life virtual world in the opposite direction. It should be obvious, as well, that the user can move any amount of degrees that they want to within 360 degrees. It should also be obvious, that the user can push button 191 and move in one direction and then move 192 and move in the opposite direction, with ease. The user does not have to move in one direction the entire time.

If the HMD Device, VR Device, or Dual HMD and VR Device 100 used with this expansion pack includes the appropriate sensors and software to allow head movements to occur, head movements may be utilized to change the users field of view, for the user to see more within their field of view, or for the user to see what they already see within their field of view at a slightly different angle.

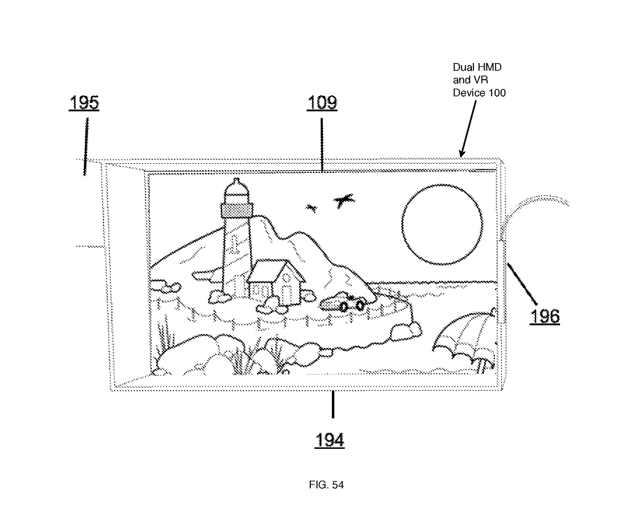

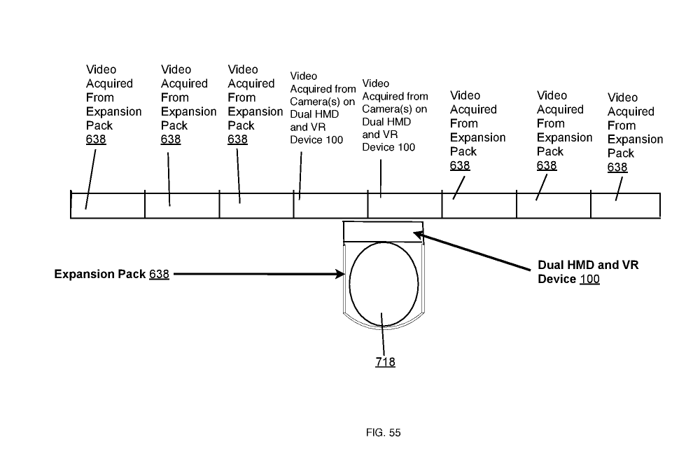

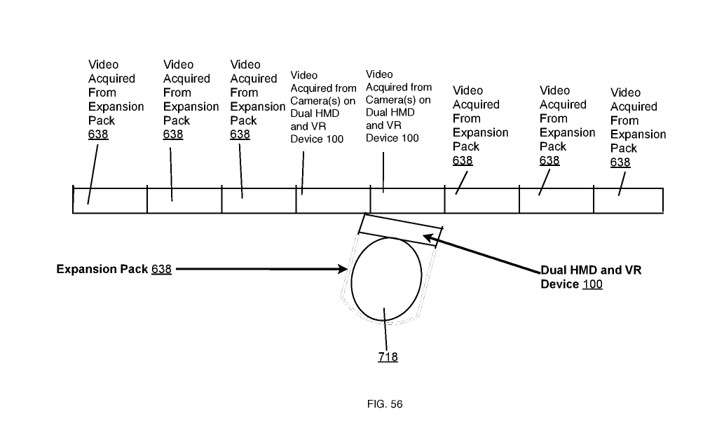

In a non limiting example, FIG. 54 shows what the user sees on display(s) 109 in their starting position. FIG. 55 is an overhead view of the position of the user 718 in their starting position. As shown in FIG. 56 the user 718 moves their head to the right. The real life virtual world does not move physically, but what the user sees in their field of view changes as shown in FIG. 57. This is similar to how humans turn their heads in real life and they either see more of the scene that they are looking at that they originally were unable to see, or they see what is in their field of view at a sightly different angle.

If the HMD Device, VR Device, or Dual HMD and VR Device 100 used with this expansion pack includes the appropriate hardware and software to allow voice recognition to occur, voice recognition can be utilized to change the position of the real life virtual world environment.

The user can use one or a combination of the following to utilize voice recognition to change their direction Within real life virtual world environment(s): degree measures, Cardinal directions (non limiting examples: North, East, South, and West), left, right, front, back, forward, behind, clockwise, counterclockwise, reverse, diagonal, or any word phrase or integer representing a direction orientation or position which exists now or is invented after the filing date of this disclosure.

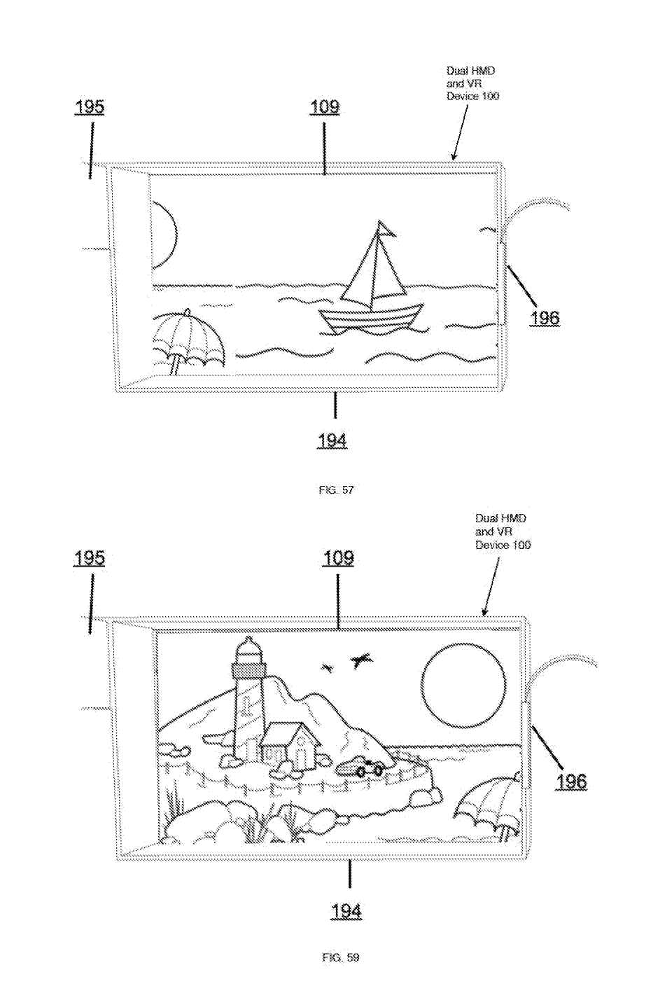

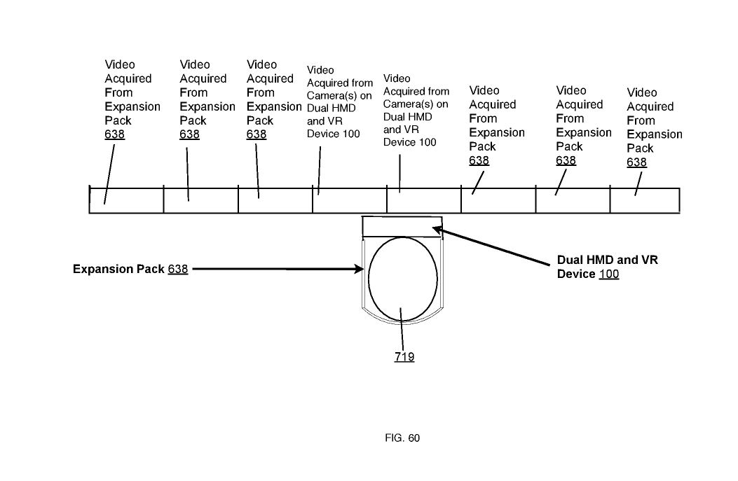

In a non limiting example, FIG. 59 shows what the user sees on display(s) 109 before changing the position of the virtual world environment. FIG. 60 is an overhead view illustrating the starting position of the real life virtual world as well as the position of the user 719 . The user activates voice recognition and says “turn right”. FIG. 61 is an overhead view which illustrates the real life virtual world moving to make the user feel as though the real life virtual world environment moved to the right. Arrow 720 in FIG. 61 illustrates the direction of movement.

As previously described, software and instructions exist to move the virtual world to the left when the user commands the real life virtual world to be moved to the right or to the right when the user commands the real life virtual world to be moved to the left. This makes the user feel as though they are physically turning around in the environment, rather than feeling like the virtual world is moving around them.

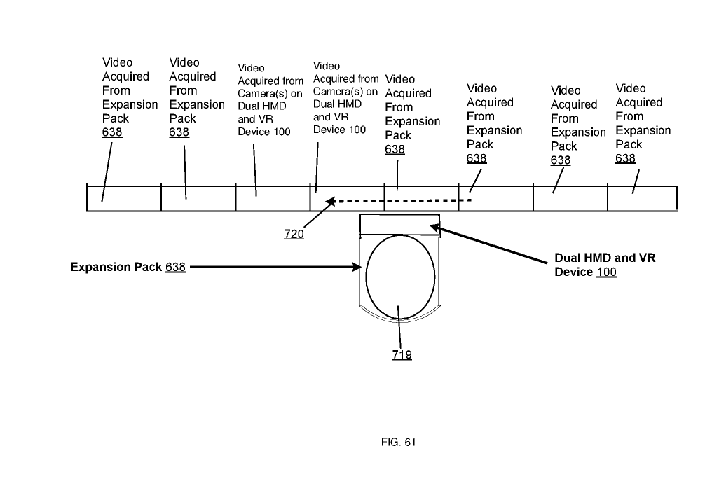

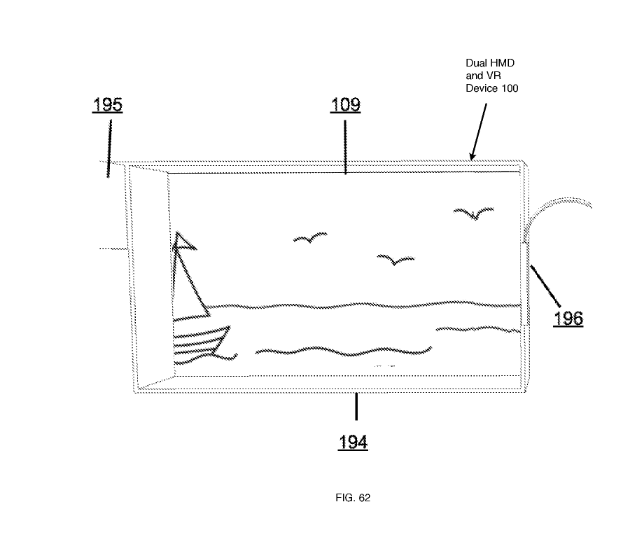

Since the real life virtual world is changing position, thus the field of view is being changed, what is shown on display(s) 109 changes as shown in FIG. 62.

In some embodiments the device continues to change the field of view and positioning of the user in the right most direction until the user says “stop” or another word which indicates stopping or discontinuing movement, when they have reached the direction they want to be in and then the graphical virtual world environment stops at the direction they want to be in.

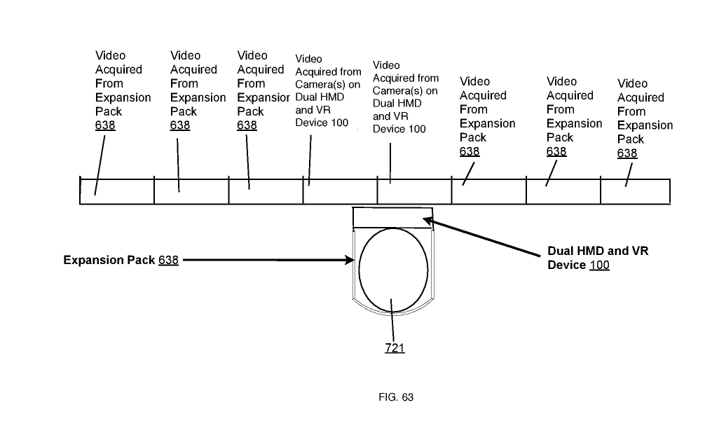

FIG. 63 is an overhead view illustrating the starting position of the real life virtual world as well as the position of the user 721 and the Real Life Virtual World Environment. FIG. 64 shows what the user sees on display(s) 109 in the position the real life virtual world environment is in FIG. 63.

In another non limiting example, the user activates voice recognition and says “move 180 degrees counterclockwise”. FIG. 65 is an overhead view with arrow 723 illustrating the direction of the real life virtual world environment begins moving in to move, 180 degrees counterclockwise. In this embodiment, the direction in which the user would move their head if they were to move it counter clockwise, is to the left. Thus the real life virtual world environment moves 180 degrees to the left. However, as previously described, software and instructions exist to move the virtual world to the left when the user commands the real life virtual world to be moved to the right or to the right when the user commands the real life virtual world to be moved to the left. This makes the user feel as though they are physically turning around in the environment, rather than feeling like the virtual world is moving around them.

Since the field of view is being changed, what is shown on display(s) 109 changes when the move is completed as shown in FIG. 66.

In some embodiments, the word face may not be used, but other words such as orient, position, or any word or phrase indicating a change in direction or that refers to direction or location which exists at the filing date of this disclosure or which may be invented after the filing date of this disclosure, may be used.

In other embodiments, the user could activate voice recognition and say “face: north west” for their position and field of view to be changed to be facing north west. The usage of cardinal directions is especially useful for direction based war, story, or quest style real life virtual world environments. In other embodiments another non-limiting the user could activate voice recognition and say “face: behind” for the user to see what is located behind them.

In most embodiments of the usage of voice recognition in regards to real life virtual world environments the software steadily turns the user's field of view, as if the user is turning in real life as illustrated in previous examples. Thus, when the user commands the real life virtual world to the right, software or instructions will move the real life virtual world to the left and vice versa. In other embodiments, the software may not turn the user in the way previously described but may just show them what they want to see without going through the process of turning the users body around. For instance, if the user said “face: behind” instead of going through the process of having the virtual world turn, the software or instructions may have what's behind the user show automatically on screen. This would take less time and less processing power.

In the examples above, the user has created a Real Live Virtual World Environment and then has immediately opened the environment they just created. It should be obvious to one skilled in the art that the user can open Real Life Virtual World Environments in which they did not just immediately create and that the user can also open environments that they've acquired from sources, such as by downloading them, that were not originally made on their device, but were made by other users using their own expansion pack 638 and Dual HMD and VR Device 100.

In some embodiments, expansion pack 628 will provide all of the camera(s) to the VR Device, HMD Device, Dual HMD and VR Device or any device which can provide an immersive experience 100 it is connected to, as not all of these devices that currently exist or that will be invented in the future, include cameras. The software which is included, in these embodiments would be stored either in the memory which is included in expansion pack 638 or on an application which can be downloaded onto the VR, HMD, or HMD and VR Device expansion pack 638 is being used with.

In these embodiments, the expansion pack 628 may be designed to fit around the VR Device, HMD Device, Dual HMD and VR Device or any device which can provide an immersive experience 100 it is connected to, as shown in FIGS. 67, 68, 69, and 70. FIG. 71 is an overhead view of Dual HMD and VR Device 100 with expansion pack 628 attached.

In FIG. 67, the front of Dual HMD and VR Device 100 is shown as well as the front of expansion pack 628. Circle(s) 920 and 921 represent one or more cameras included within the expansion pack 628.

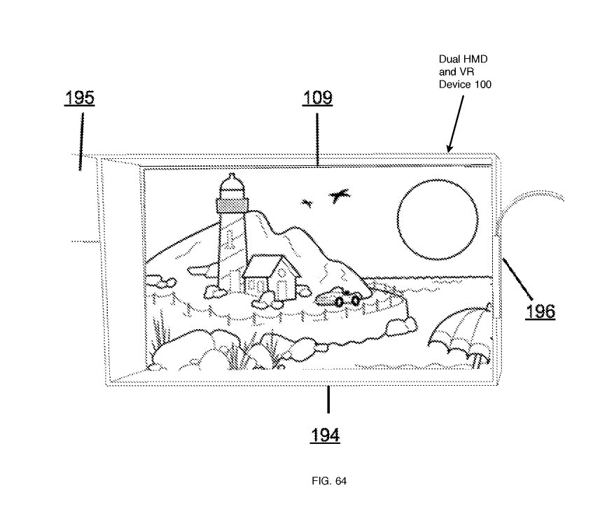

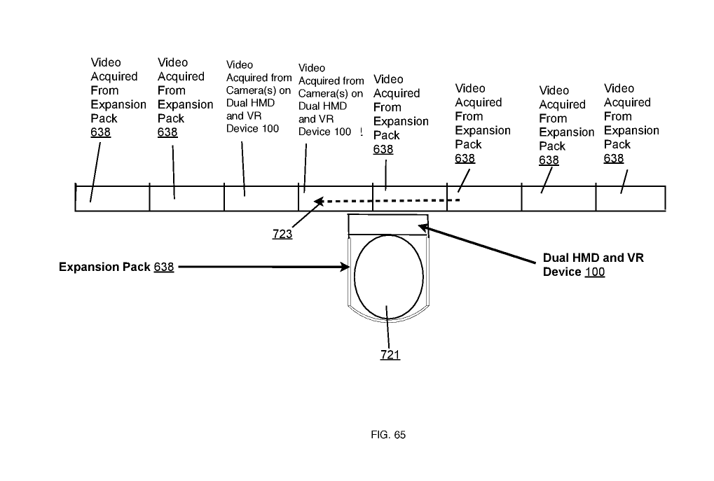

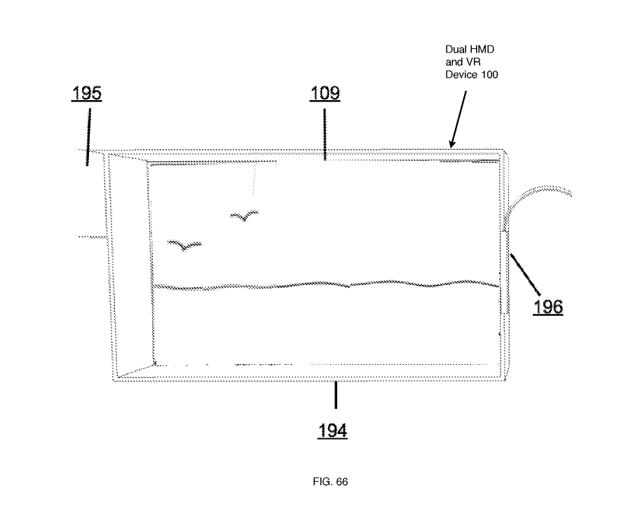

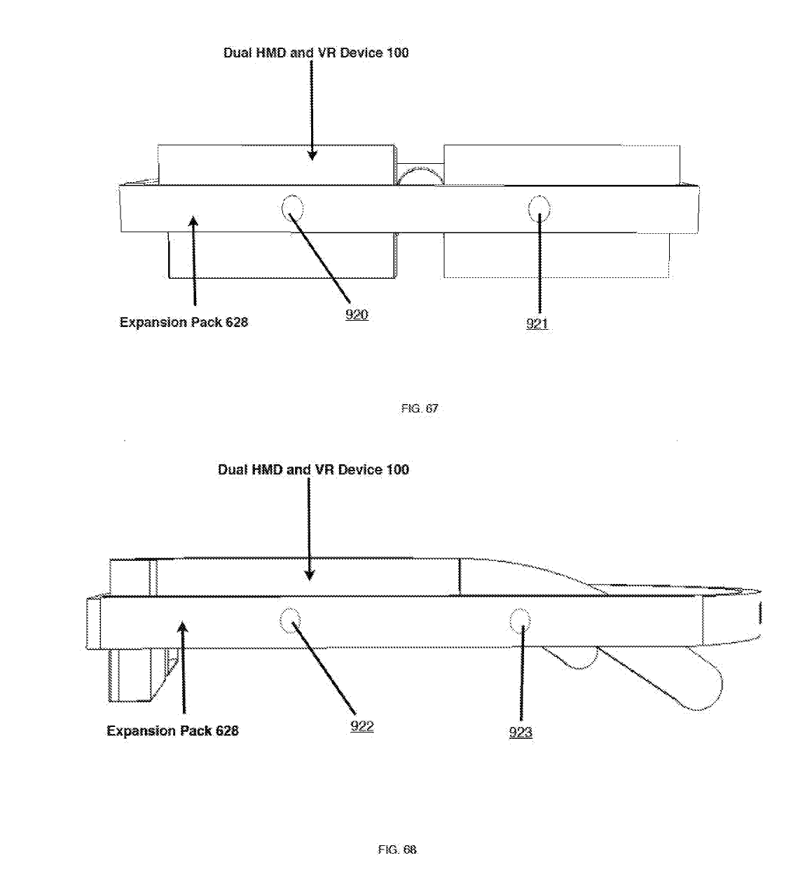

In FIG. 68, the left of Dual HMD and VR Device 100 is shown as well as the left of expansion pack 628. Circle(s) 922 and 923 represent one or more cameras included within the expansion pack 628.

In FIG. 69, the back of Dual HMD and VR Device 100 is shown as well as the back of expansion pack 628. Circle(s) 924 and 925 represent one or more cameras included within the expansion pack 628.

In FIG. 70, the right of Dual HMD and VR Device 100 is shown as well as the right of expansion pack 628. Circle(s) 926 and 927 represent one or more cameras included within the expansion pack 628.

There are eight (8) total cameras included within expansion pack 628, in this embodiment. It should be obvious to one skilled in the art that more or less camera(s) can be included than what is shown here, as previously described. Also, as previously described, these camera's are also spaced 62-64 mm apart from each other, which is known as the average distance between both pupils in humans.

Expansion pack 628, in this embodiment, is thought to be made of plastic and clip or otherwise attach onto Dual HMD and VR Device 100. To one skilled in the art, it should be apparent that expansion pack 628 could be made out of many different materials, from normally seen materials such as plastic, to more abstract configurations such as the included cameras and hardware being sewn into a cloth which acts as a strap, and is able to be strapped onto the VR, HMD, or Dual HMD and VR device it is being used with so it will sit in a position which is similar to the one that expansion 628 sits in as shown in FIGS. 67, 68, 69, and 70. Expansion pack 628 may be made out of any appropriate material which exists at the filing date of this disclosure or is invented beyond the filing date of this disclosure.

It should also be apparent to those skilled to the art that many acceptable methods can be devised to allow the expansion pack 628 to attach to the VR, HMD, or Dual HMD and VR device it is being used with such as normally seen methods like the expansion pack being molded to clip around the device securely, to abstract methods such as the device attaching to the device by use of velcro. Any appropriate method which exists at the filing date of this disclosure or is invented beyond the filing date of this disclosure, may be used to allow expansion pack 628 to securely attach to the VR Device, HMD Device, Dual HMD and VR Device or any device which can provide an immersive experience that it is being used with.

In some embodiments, expansion pack 628 may be adjustable to accommodate different shaped devices, using any method that exists at the time of the filing of this disclosure or any method which may be invented beyond the filing date of this disclosure which is appropriate for expansion pack 628 to be adjustable.

It also should be obvious to one skilled in the art that expansion pack 628 may differ in shape to be able to fit around a VR Device, HMD Device, Dual HMD and VR Device or any device which can provide an immersive experience with ease.

In another version of the second aspect of the invention, expansion pack 628, expansion pack 628 can be used without a VR Device, HMD Device, Dual HMD and VR Device or any device which can provide an immersive experience 100 to capture video to create real life virtual world environments.

In this version of the invention, the expansion pack 628 is designed to fit around the users head, as shown in FIG. 71A, 72, 73, and 74.

In FIG. 71A, the front of Dual HMD and VR Device 100 is shown as well as the front of expansion pack 628. Circle(s) 926 and 927 represent one or more cameras included within the expansion pack 628.

In FIG. 72, the left of Dual HMD and VR Device 100 is shown as well as the left of expansion pack 628. Circle(s) 928 and 929 represent one or more cameras included within the expansion pack 628.

In FIG. 73, the back of Dual HMD and VR Device 100 is shown as well as the back of expansion pack 628. Circle(s) 930 and 931 represent one or more cameras included within the expansion pack 628.

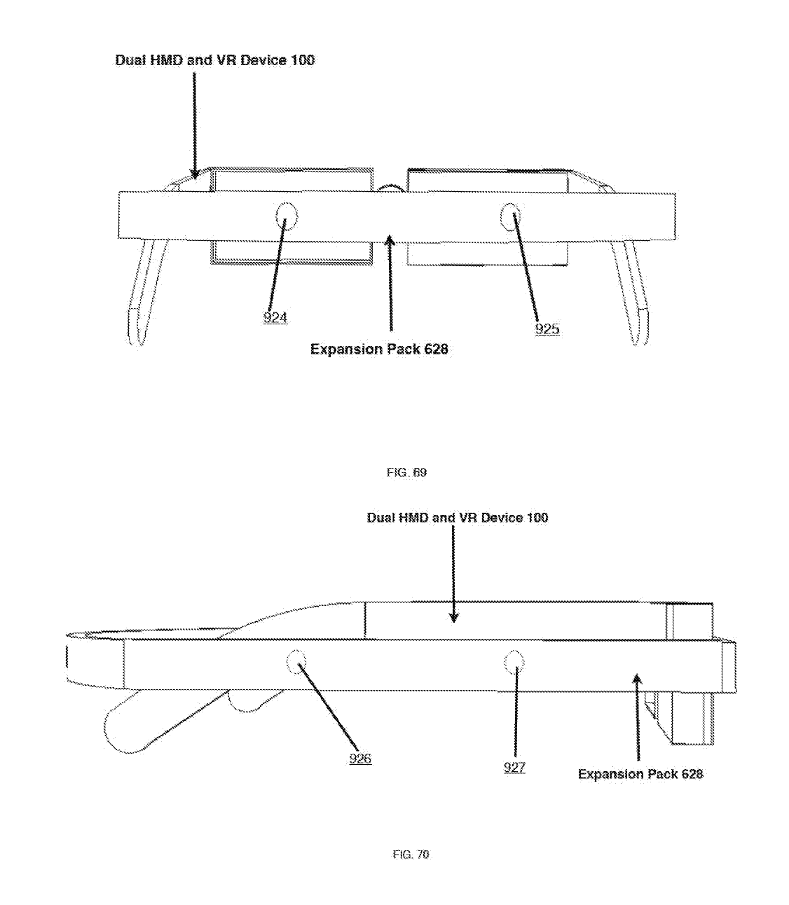

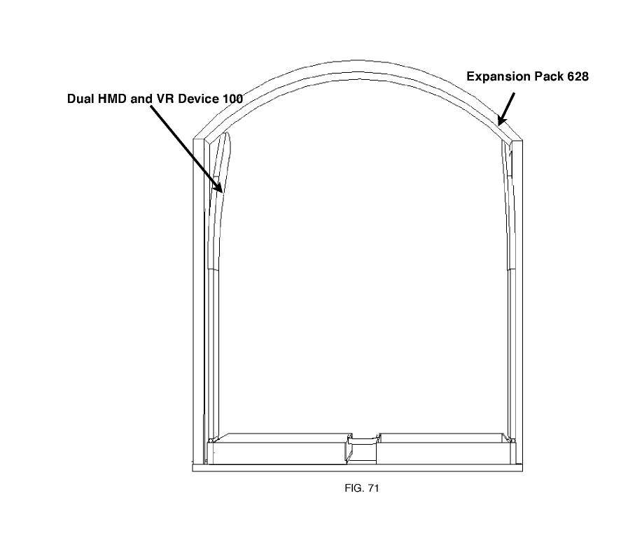

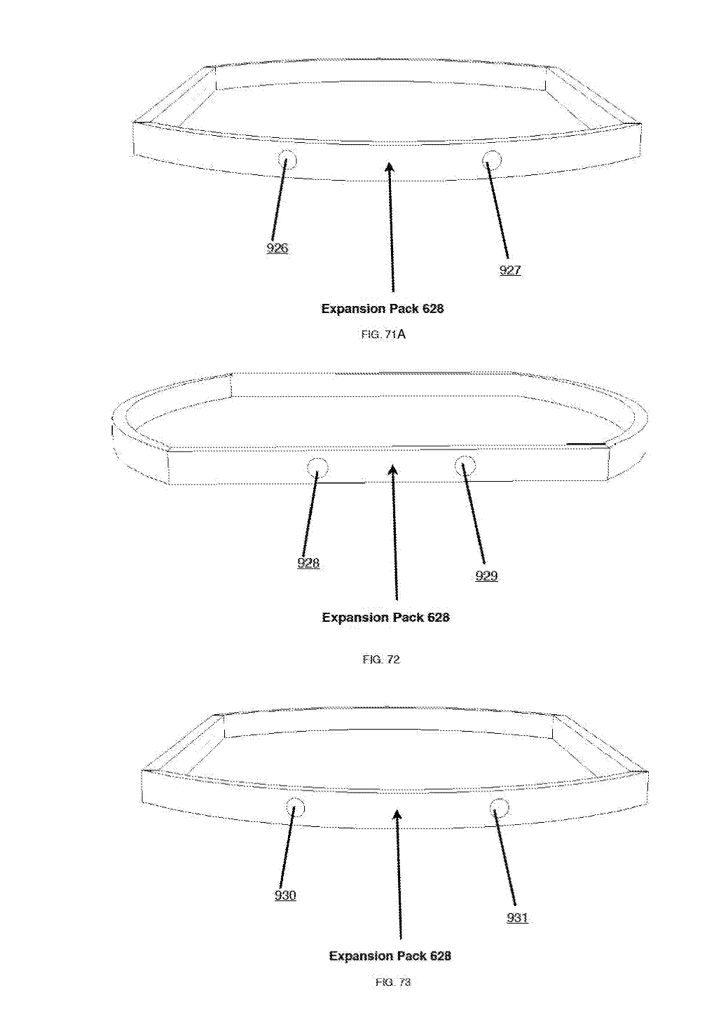

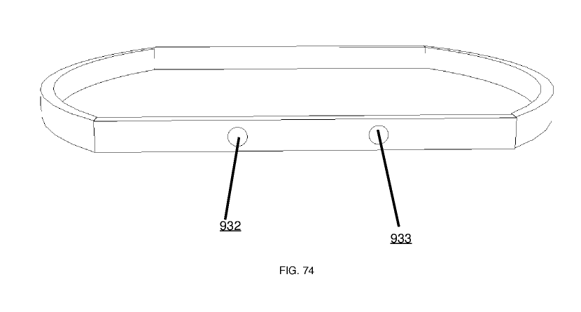

In FIG. 74, the right of Dual HMD and VR Device 100 is shown as well as the right of expansion pack 628. Circle(s) 932 and 933 represent one or more cameras included within the expansion pack 628.

There are eight (8) total cameras included within expansion pack 628, in this embodiment. It should be obvious to one skilled in the art that more or less camera(s) can be included than what is shown here, as previously described. Also, as previously described, these camera's are also spaced 62-64 mm apart from each other, which is known as the average distance between both pupils in humans.

It should be obvious that expansion pack 628 differs in shape compared to previous examples to be able to fit a human head with ease. It should be also be obvious that expansion pack 628 may be a different shape than the shape it is in in these examples to accommodate different shaped heads. In some embodiments, expansion pack 628 may be adjustable to accommodate different shaped heads, using any method that exists at the time of the filing of this disclosure or any method which may be invented beyond the filing date of this disclosure which is appropriate for expansion pack 628 to be adjustable.

Expansion pack 628, in this embodiment, is thought to be made of plastic and slides over the users head to fit, similar to how a user would put on a baseball cap. To one skilled in the art, it should be apparent that expansion pack 628 could be made out of many different materials, from normally seen materials such as plastic, to more abstract configurations such as the included cameras and hardware being sewn into a cloth which acts as a strap, and is able to be strapped onto the head with ease. Expansion pack 628 may be made out of any appropriate material which exists at the filing date of this disclosure or is invented beyond the filing date of this disclosure.

It should also be apparent to those skilled to the art that many acceptable methods can be devised to allow the expansion pack 628 to attach to the user's head it is being used with such as normally seen methods like the plastic of expansion pack 628 being a generic shape or expansion pack 628 being custom molded to fit around the specific user's head. Any appropriate method which exists at the filing date of this disclosure or is invented beyond the filing date of this disclosure, may be used to allow expansion pack 628 to securely fit on the head of the user who is using the device.

This version of the second aspect of the invention, expansion pack, requires connection over a bi-directional communication link between expansion pack 628 and a wireless device. Thus, expansion pack 628 contains RF circuitry as previously described within this disclosure.

RF circuitry is utilized to establish a bi-directional communication link between the expansion pack and the wireless device that expansion pack 628 is being used with.

The wireless device has an application installed onto it which contains software or instructions to manage the capture of these real life virtual world environments. It should be noted that in this version of expansion pack 628, expansion pack 628 exists to capture and create real life virtual world environments, not to provide the user a means of experiencing them. The user would experience these environments on the wireless device application, on a desktop computer, or on a VR Device, HMD Device, Dual HMD and VR Device or any device which can provide an immersive experience 100. This process will now be described.

Software or instructions are contained in this version of expansion pack 628 to establish a bi-directional communication link between itself and a wireless device, such as a bluetooth enabled handset. Bluetooth is a non limiting example of a technology which allows bi-directional communication links to occur. Once this bi-directional communication link is established, the user then launches an application 901 installed on the wireless device created specifically for use with expansion pack 628.

Application 901 is installed on wireless device 902 as shown in FIG. 75, contains software or instructions to allow the user to command the expansion pack 628 to record video to create real life virtual world environments. In this non limiting example, the wireless device the user has the application installed onto and connected to expansion pack 628, has a touch screen.

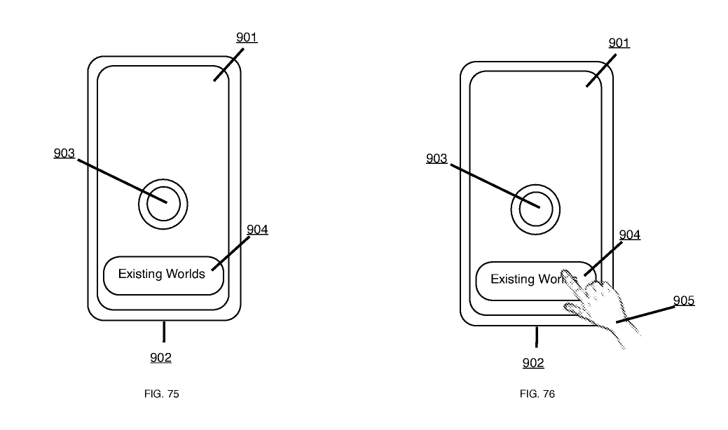

In FIG. 76 the user 905 taps or otherwise selects record button 903 within application 901. As a result of the user performing this action, application 901, over the bi-directional communication link established between expansion pack 628 and application 901, commands expansion pack 628 to begin to record videos from the camera(s) included in expansion pack 628.

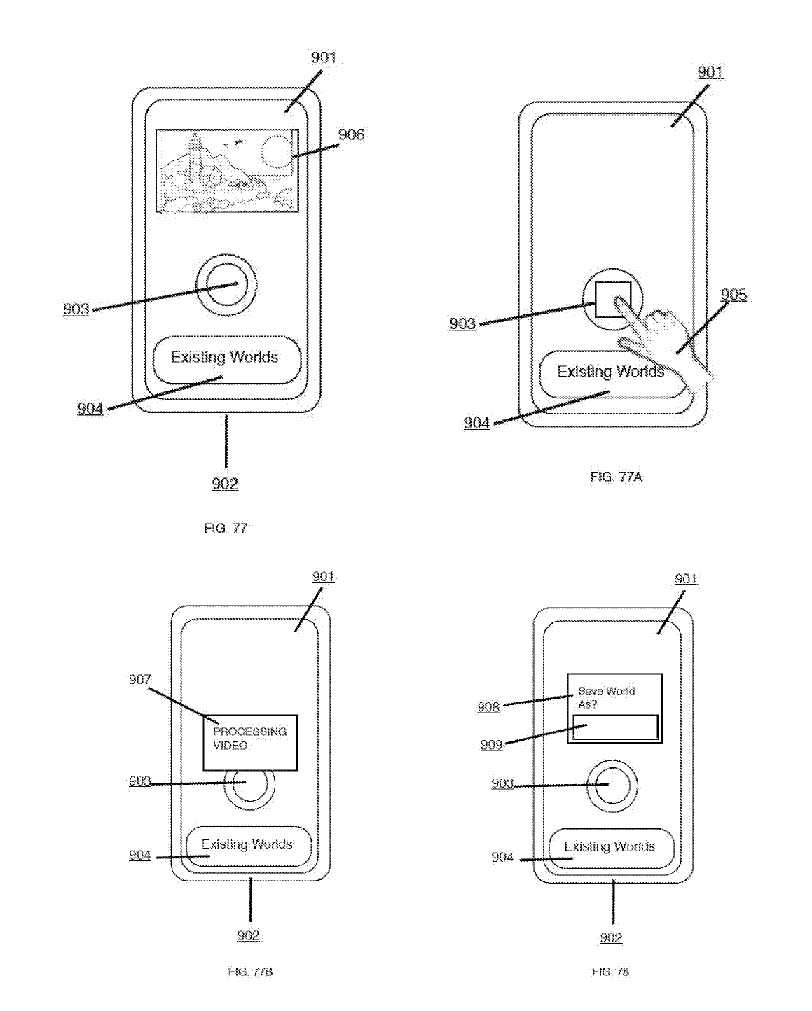

In some embodiments, as shown in FIG. 77, the user may be provided with a view 906 of what each camera sees on the same screen where the record button is located in application 901. The microprocessing unit(s) 639 of expansion pack 628 begin to execute software or instructions which are stored in removable computer readable storage media 642 that contain software or instructions to execute as a result of the user pressing record button 903 within the wireless device application 901.

These software(s) or instruction(s) include directions to capture video from each camera, to store the acquired video in removable computer readable storage media 642 of expansion pack 628, and directions to store data with each video regarding the position that the video is shot in either based off of the positioning of the cameras or the position that the camera is situated in, in terms of degrees in a circle while it is being captured.

When the user 905 is done capturing the video that they want to create a real life virtual world environment, they press the record button 903, as shown in FIG. 77A which bears a stop icon as the user is currently recording video, to stop recording video. Once the user 905 presses record button 903 to stop recording video, application 901 commands expansion pack 628 over the bi-directional communication link established between the wireless device and expansion pack 628 to stop recording video.

As a result of receiving this command, microprocessing units of expansion pack 628 begin to execute software or instructions which are stored in removable computer readable storage media 642 that contain software or instructions to stitch the video, into one seamless scene of video. While this occurs, expansion pack 628 sends data stating that it is current stitching video to the application 901 installed on the wireless device. As a result, the application 901 displays a message or graphic stating 907 that the video is being stitched or processed, as shown in FIG. 77B. When expansion pack 628 is done stitching the video into one seamless scene, expansion pack 628 sends data regarding that it has completed the stitching process over the bi-directional communication link established between the wireless device and expansion pack 628, which is received by the application 901. As a result, in some embodiments, the application may display a prompt or dialog box 908 to prompt the user to give the real life virtual world environment a title, as shown in FIG. 78. The user would then interact with text area 909 to insert a title. In some embodiments, after the user is done creating the real life virtual world environment, they will have the option to edit the video or video(s) which make up the real life virtual world environment with tools similar to those that exist in video editing software(s). Non limiting examples of these tools include: cropping video, editing the timing of a video, changing the appearance of a video (example: color or filter options), editing audio levels, editing a video's position, adding audio tracks, and the like. In some embodiments, while the Real Life Virtual World Environment is being saved, software or instructions may exist to automatically edit and adjust the video, such as cropping out unnecessary objects.

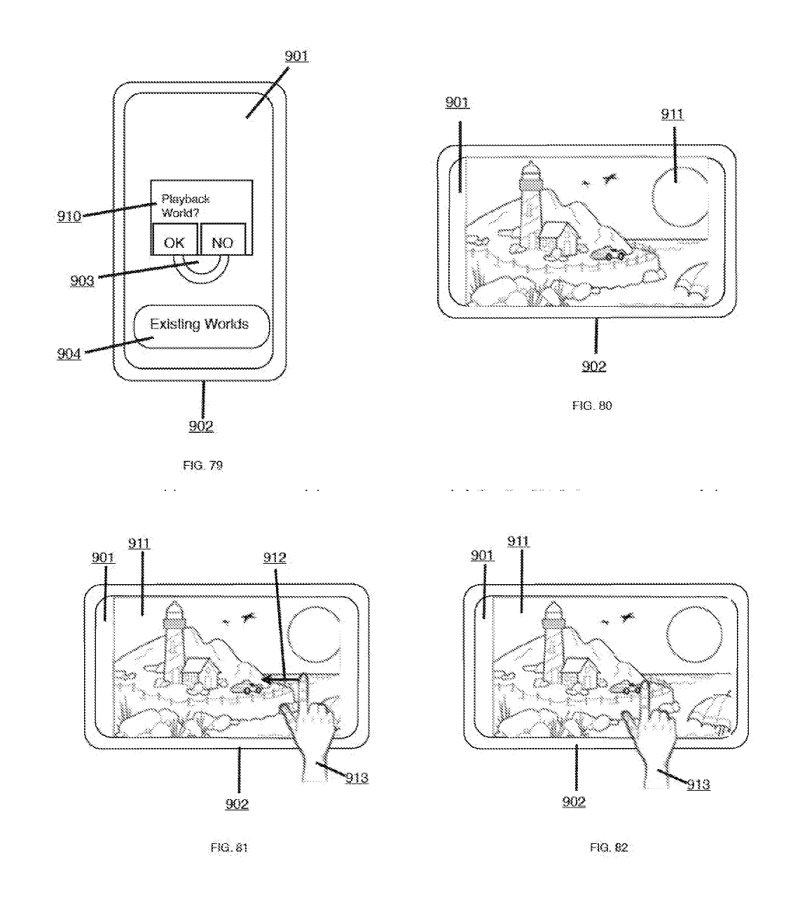

In other embodiments, the user may be shown a prompt or dialog box 910, asking if they'd like to playback the real life virtual world environment that was created, as shown in FIG. 79. If the user chooses to playback the real life virtual world environment, the application 901, over the bi-directional communication link established between the wireless device 902 and expansion pack 628, commands expansion pack 628 to begin streaming the video over the bi-directional communication link between the wireless device 902 and expansion pack 628 so that the video can be shown to the user within application 901. Upon receiving this command, microprocessing unit(s) 639 of expansion pack 628 begins to stream video to the wireless device application 901 over the bi-directional communication link between the two devices.

As shown in FIG. 80, the real life virtual world environment 911 is shown within application 901. The wireless device 902, is in landscape orientation. Like most wireless devices on the market at the time of this disclosure, wireless device 902 contains sensors and software components to allow the user changing the orientation of the wireless device to change the orientation of on screen applications and content. It should be noted that the real life virtual world can be shown regardless if the phone is in portrait or landscape orientation.

In some embodiments, the user may be able to use swipes and taps to move the real life virtual environment around. In FIG. 81 the user 913 is preparing to swipe the real life virtual world to the left in the direction which is illustrated by arrow 912. In FIG. 82, the user 913 has just completed swiping in the direction illustrated ye arrow 912 in the previous example, and as a result more of the real life virtual world environment is shown on screen, as shown. In some embodiments the user may use multi finger movements which may be known as gestures to expand or enlarge the real life virtual world environment. A non limiting example of this would be the user making a pinch like gesture on the screen of the wireless device to enlarge an area of the real life virtual world environment that they'd like to see enlarged.

From this point the user would then have the option to save the real life virtual world environment or discard it.

As previously discussed, the intent of this version of the expansion pack is to only create real life virtual world environments, and to not have a method of playback that is as immersive as wearing a VR Device, HMD Device, Dual HMD and VR Device or any device which can provide an immersive experience 100 to view these real life virtual worlds. As shown in FIG. 83, if the user 914 taps or otherwise interacts with button 904 of application 901 on the wireless device, the wireless device sends a request over the bi-directional communication link to expansion pack 628 for a listing of all of the real life virtual world environments stored within removable computer readable storage media 642 of expansion pack 628. As a result, expansion pack 628 sends, over the bidirectional communication link between wireless device 902 and expansion pack 628, a listing of all the real life virtual world environments stored within it's removable computer readable storage media 642, to the wireless device 902. Once the wireless device receives this data, the listing of the real life virtual word environments are then shown within application 901. The user can tap or otherwise interact with any of the real life virtual world environments to play it back within application 901.

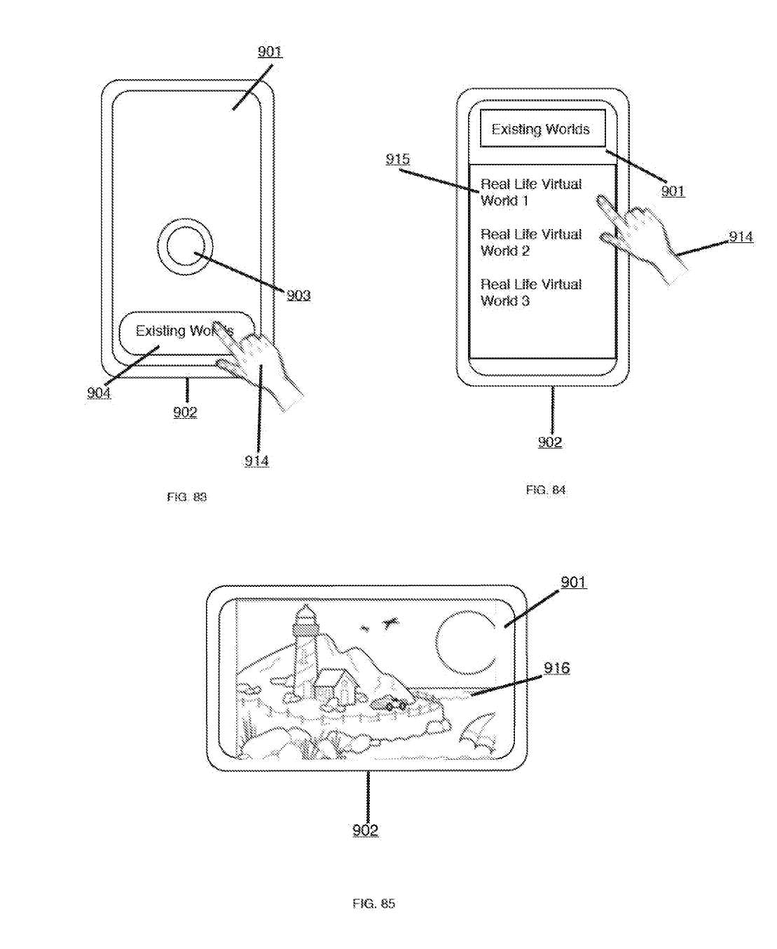

In a non limiting example, the user selects Real Life Virtual World 1 915, for playback as shown in FIG. 84. Once this is selected the application 901, over the bi-directional communication link established between the wireless device 902 and expansion pack 628, commands expansion pack 628 to begin streaming the video over the bi-directional communication link between the wireless device 902 and expansion pack 628 so that the video can be shown to the user within application 901. Upon receiving this command, microprocessing unit(s) 639 of expansion pack 628 begins to stream video to the wireless device application 901 over the bi-directional communication link between the two devices. As shown in FIG. 85, the real life virtual world environment 916 is shown within application 901. As previously described, in some embodiments, the user may be able to use swipes and taps to move the real life virtual environment around. As previously discussed, in some embodiments, the user may use use finger movements or other interactions with the wireless device to move, enlarge, or otherwise interact with the real life virtual world environment.

In many instances, the user likely will create the real life virtual world environments using expansion pack 628 and then connect expansion pack 628 to another device such as a computer to share it over the internet, onto a server, onto a cloud, within an application, or the like. In some embodiments, the real life virtual world may not even be saved to the expansion pack 628, it may be saved directly onto a cloud, server, application, or other storage device in which the device may be connected to.

In some embodiments, expansion pack 628 it is designed have more than one function, so it is able to be used either as a standalone device or as an attachment for an immersive device such as an VR, HMD, or HMD and VR Device. In these embodiments, expansion pack 628 contains all of or aspects of the aforementioned software and or instructions.

What is claimed is:

1. A device, to shoot 360 degrees of seamless video, comprises:
one or more microprocessing unit(s);
one or more camera(s);
wherein the one or more camera(s) are positioned so that what each camera sees in it's field of view intersects slightly with the camera or camera(s) in which it resides next to;
computer readable storage media;
RF circuitry;
an external port connector,
wherein the microprocessing unit(s) contain one or more programs or sets of instructions, including:
instructions to capture 360 seamless video from a plurality of cameras;
instructions to obtain data on the position that each video was captured in based off of the positioning of the cameras, and instructions to save each video that has been captured along with the data on the position it was captured in on the computer readable storage media; and
instructions to stitch or arrange the video that was captured into one seamless scene accurately according to the data obtained on the position of each video, and instructions to save this data on the stitching and positioning of each video on the computer readable storage media.
The device of claim 1 consisting of:
one or more microprocessing unit(s);
one or more camera(s);
wherein the one or more camera(s) are positioned so that what each camera sees in it's field of view intersects slightly with the camera or camera(s) in which it resides next to;
computer readable storage media;
an external port connector,
wherein the microprocessing unit(s) contain one or more programs or sets of instructions, including:
instructions to work in unison with software stored on any one of a plurality of devices which provide an immersive experience such as but not limited to HMD or VR devices which is connected to the device of claim 1, to capture 360 seamless video from a plurality of cameras.
The device of claim one further comprising one or more programs or sets of instructions, including:
instructions to detect if any one of a plurality of devices which provide an
immersive experience such as but not limited to HMD or VR devices is connected to the device of claim 1.
The device of claim 1 further comprising one or more programs or sets of instructions, including: instructions which do not include the stitching or arranging of video.
The the device of claim 1 further comprising one or more programs or sets of instructions; including, instructions to allow the video that has been captured to be edited by the use of video editing tools including but not limited to cropping video, editing the timing of a video, changing the appearance of a video, editing audio levels, editing a video's position, adding audio tracks, and the like.
The device of claim 1 further comprising one or more programs; including, instructions to allow the video captured by the device of claim 1 and the data the device of claim 1 obtains on the position the video is being captured as well as, if present, the video captured by a connected device which provides an immersive experience such as but not limited to an HMD or VR devices and the data a connected device which provides an immersive experience such as but not limited to an HMD or VR devices obtains on the position of the video being captured, to be saved onto a cloud, server, application, or other storage service or device in which the device of claim 1 or a connected device which provides an immersive experience such as but not limited to an HMD or VR devices may be connected to or may establish a connection to.

2. A method comprising one or more programs; including,
instructions to capture video from the device of claim 1 from multiple cameras included in the device of claim 1 and if present, from cameras included in a device which is connected to the device of claim 1 which is a device that provides immersive experience such as but not limited to HMD or VR devices simultaneously,
instructions to obtain data on the position each video was captured in based off of the positioning of the cameras;
instructions to save each video that has been captured along with the data on the position it was captured in on one or a combination of the following: the computer readable storage media of the device of claim 1 or the computer readable storage media within the device that the device of claim 1 is being used with;
instructions to, once the user commands video to stop recording, to stitch or arrange the video that was captured into one seamless scene accurately according to the data obtained on the position of each video;
instructions to save this data on the stitching and positioning of each video on one or a combination of the following: the device of claim 1 or the device in which the device of claim 1 is being used with, so it is available when the user wants to play back these 360 degrees of seamless video;
instructions that when 360 degrees of seamless video is played back to allow the video extend past the boundaries of the displays of the device it is being played back on;
instructions to position the 360 degrees of seamless video based on the position it was captured in while it is being played back so the video remains seamless; and
instructions to allow the user to be able to move, enlarge, or otherwise interact with the 360 degrees of seamless video so they are able to see more of it while it is playing back.
The method of claim two, further comprising one or more programs or sets of instructions, including: instructions to allow the user to be able to turn or move the 360 degrees of seamless video to see more of it; and
instructions that when the user commands the 360 degrees of video to turn or move, the 360 degrees of video moves in the direction opposite of the direction the user commanded it to move in.
The method or claim 2 further comprising one or more programs or sets of instructions, including: instructions which do not include the stitching or arranging of video.
The method of claim 2 further comprising one or more programs; including, instructions to allow the video that has been captured to be edited by the use of video editing tools including but not limited to cropping video, editing the timing of a video, changing the appearance of a video, editing audio levels, editing a video's position, adding audio tracks, and the like.
The method of claim 2 further comprising one or more programs; including, instructions to allow the video captured by the device of claim 1 and the data the device of claim 1 obtains on the position the video is being captured as well as, if present, the video captured by a connected device which provides an immersive experience such as but not limited to HMD or VR devices and the data a connected device which provides an immersive experience such as but not limited to HMD or VR devices obtains on the position of the video being captured, to be saved onto a cloud, server, application, or other storage service or device in which the device of claim 1 or a connected device which provides an immersive experience such as but not limited to HMD or VR devices may be connected to or may establish a connection to.

3. A wireless device application comprising one or more programs; including, instructions to establish a bi-directional communication link between the wireless device application and the device of claim 1;
instructions to allow the user to command over the bi-directional communication link established between the device of claim 1 and the wireless device application the capture of videos from multiple cameras included in the device of claim 1;
instructions to as a result of the user commanding, over the bi-directional communication link established between the device of claim 1 and the wireless application, the capture of videos from multiple cameras on the device of claim 1, to simultaneously command that one or more programs stored on the computer readable storage media of the device of claim 1 execute on the microprocessing units of the device of claim 1, these programs include instructions to obtain data on the position each video was captured in, and instructions to save each video that has been captured along with the data on the position it was captured in on the computer readable storage media of the device of claim 1;
instructions to allow the user command over the bi-directional communication link established between the device of claim 1 and the wireless device application to end the capture of videos from multiple cameras included in the device of claim 1;
instructions to as a result of the user commanding, over the bi-directional communication link established between the device of claim 1 and the wireless application, to end the capture of videos from multiple cameras on the device of claim 1, to simultaneously command that one or more programs stored on the computer readable storage media of the device of claim 1 execute on the microprocessing units of the device of claim 1, these programs include instructions to stitch or arrange the video that was captured into one seamless scene accurately according to the data obtained on the position of each video, and instructions to save this data on the stitching and positioning of each video on the device of claim 1;
instructions to allow the user to request from the wireless device application over the bi-directional communication link established between the device of claim 1 and the wireless device application a listing of all of the 360 degree seamless videos stored on the device of claim 1;
instructions to allow the user command over the bi-directional communication link established between the device of claim 1 and the wireless device application the playback of a 360 degrees of seamless video which is stored within the computer readable storage media of the device of claim 1 within the wireless device application;
instructions to as a result of the user commanding, over the bi-directional communication link established between the device of claim 1 and the wireless application, to playback 360 degrees of seamless video which is stored within the computer readable storage media of the device of claim 1 within the wireless device application to simultaneously command the microprocessing units of the device of claim 1 to begin streaming the 360 degree video which the user selected that is stored in the computer readable storage media of the device of claim 1 over the bi-directional communication link established between the device of claim 1 and the wireless device to be received by the wireless device application;
instructions to as the 360 degrees of seamless video is being streamed to the wireless device application, position the 360 degrees of seamless video which is being played back based on the position it was captured in so the video remains seamless and instructions to allow the user to be able to move, enlarge, or otherwise interact with the 360 degrees of seamless video which is being played back so they are able to see more of it while it is playing back.
The application of claim 3 further comprising one or more programs; including, instructions to allow the user to see what each camera from the device of claim 1 sees before and in some embodiments during the capture of video.
The application of claim 3 further comprising one or more programs; including, instructions to allow the video captured by the device of claim 1 and the data the device of claim 1 obtains on the position the video is being captured, to be saved onto the wireless device or onto a cloud, server, application, or other storage service or device in which the wireless device may be connected to or may establish a connection to.
The application of claim 3 further comprising one or more programs; including, instructions to allow the video that has been captured to be edited by the use of video editing tools including but not limited to cropping video, editing the timing of a video, changing the appearance of a video, editing audio levels, editing a video's position, adding audio tracks, and the like.
